(19) United States
(12) Patent Application Publication
(10) Pub. No.: US 2009/0104380 A1
(43) Pub. Date: Apr. 23, 2009

(54) Production method of liquid crystal display unit and spacer particle dispersion liquid

(76) Inventors: Michihisa Ueda, Osaka (JP); Kazushi Ito, Osaka (JP); Takeshi Wakiya, Osaka (JP); Yasuharu Nagai, Osaka (JP); Yasushi Uematsu, Osaka (JP)

Correspondence Address: WENDEROTH, LIND & PONACK, L.L.P., 1030 15th Street, N.W.,, Suite 400 East, Washington, DC, 20005-1503, US

(21) Appl. No.: 11/921,002

(22) PCT Filed: May 29, 2006
(86) PCT No.: PCT/JP2006/310693

§ 371 Date: Feb. 19, 2008

(30) Foreign Application Priority Data
May 27, 2005 (JP) 2005-156416
Dec. 6, 2005 (JP) 2005-352546
Dec. 6, 2005 (JP) 2005-352547

(51) Int. Cl. C09K 19/02; C08L 37/00; C09D 11/10; B05D 5/12

(52) U.S. Cl. 428/1.54; 524/548; 106/31.13; 427/58

(57) ABSTRACT

It is an object of the invention to provide a method of producing a liquid crystal display device which comprises steps of depositing droplets of a spacer particle dispersion at prescribed positions on a substrate by ejecting the spacer particle dispersion with an ink-jet apparatus, then drying the droplets, and thereby arranging the spacer particles on the substrate, which may arrange the spacer particles precisely at prescribed positions, and a spacer particle dispersion preferably usable for the method of producing a liquid crystal display device.

A method of producing a liquid crystal display device, which comprises a step of ejecting a droplet of a spacer particle dispersion with an ink-jet apparatus, depositing the droplet at a prescribed position on a substrate, then drying the droplet, and thereby arranging the spacer particle on the substrate, the spacer particle dispersion comprising a spacer particle, an adhesive component and a solvent, the spacer particle after the drying being arranged in a narrower region than the diameter of the droplet of the spacer particle dispersion deposited on the substrate.

### TECHNICAL FIELD

The invention relates to a method of producing a liquid crystal display device which comprises steps of depositing droplets of a spacer particle dispersion at prescribed positions on a substrate by ejecting the spacer particle dispersion with an ink-jet apparatus, then drying the droplets, and thereby arranging the spacer particles on the substrate, which may arrange the spacer particles precisely at prescribed positions, and a spacer particle dispersion preferably usable for the method of producing a liquid crystal display device.

### BACKGROUND ART

A liquid crystal display device has been used widely for personal computers and mobile type electronic appliances. The liquid crystal display device generally comprises two substrates on which a color filter, a black matrix, a linear transparent electrode, an alignment layer, and the like are formed and a liquid crystal sandwiched between the substrates. Herein, the spacer particles regulate the distance between two substrates and maintain a proper thickness of the liquid crystal layer.

As a method for arranging the spacer particles in the method of producing the liquid crystal display device have been employed wet dispersion methods for spraying the particles using a solvent such as isopropanol and the like and dry dispersion methods for spraying spacer particles by utilizing pressure of air without using a solvent. However by these production methods, the spacer particles are randomly arranged and it sometimes results in a problem that the spacer particles are arranged even on display parts (pixel regions) of a liquid crystal display device.

The spacer particles are generally made of a synthetic resin or glass and if the spacer particles are arranged on pixel electrodes, the spacer particle parts may become causes of light leakage due to the depolarization. Further, when the alignment of the liquid crystal on the surfaces of the spacer particles is disturbed, light pass is caused to lower the contrast and the color tone and deteriorate the display quality. With respect to a TFT liquid crystal display device, when the spacer particles are arranged on a TFT element on a substrate, the element has been sometimes broken in the case a pressure is applied to the substrate.

In order to solve the problems caused along with the random spraying of the spacer particles, various investigations and examinations for arranging the spacer particles under the light-blocking regions (non-pixel regions) have been tried. As a method for arranging the spacer particles only on prescribed positions, Patent Document 1 discloses a method of putting a mask having aperture parts while properly positioning the mask in a desired position and then spraying the spacer particles through the mask. Patent Document 2 discloses a method of electrostatically adsorbing the spacer particles to a photoconductor and then transferring the spacer particles to a transparent substrate. Patent Document 3 discloses a method of producing a liquid crystal display device by applying voltage to pixel electrodes on a substrate, spraying charged spacer particles, and thereby arranging the spacer particles to prescribed positions based on the electrostatic repulsion.

However, with respect to the methods described in Patent Document 1 and Patent Document 2, there is a problem that the alignment layer on the substrate is sometimes damaged since the mask or the photoconductor is directly brought into contact with the substrate and accordingly the image quality becomes inferior. Further, with respect to Patent Document 3, since electrodes in patterns for the arrangement are required, it is impossible to arrange the spacer particles at optional positions.

On the other hand, Patent Document 4 discloses a method which comprises steps of ejecting droplets of a spacer particle dispersion using an ink-jet apparatus, depositing the droplets on prescribed positions on a substrate, then drying the droplets and thereby arranging the spacer particles on the substrate. According to this method, no mask is brought into contact with the substrate and the spacer particles are arranged at optional positions.

However, in recent liquid crystal display devices having extremely fine pitches, the positions such as black matrix where the spacer particles are to be arranged are very narrow and in some cases even narrower than the diameter of the droplets of the spacer particle dispersion and it has been difficult to precisely arrange the spacer particles even by the method disclosed in Patent Document 4. Further, during the period from the deposition of the droplets of the spacer particle dispersion to the drying the droplets, the spacer particles are moved due to the outside pressure such as vibration and accordingly it leads to a problem that the spacer particles cannot be arranged in prescribed positions.

Patent Documents 5 and 6 disclose methods of adding an adhesive to a spacer particle dispersion and thereby improving the cohesive power of the spacer particles on a substrate. However, actually, there were problems that the arrangement failure due to the movement of the spacer particles cannot be prevented or the adhesive enters between the spacer particles and the substrate to make the cell gap uneven. Further, there occurs a problem that the solvent or the adhesive of the spacer particle dispersion penetrates the alignment layer on a substrate.

Patent Document 1: Japanese Kokai Publication Hei-4-198919

Patent Document 2: Japanese Kokai Publication Hei-6-258647

Patent Document 3: Japanese Kokai Publication Hei-10-339878

Patent Document 4: Japanese Kokai Publication Sho-57-58124

Patent Document 5: Japanese Kokai Publication Hei-9-105946

Patent Document 6: Japanese Kokai Publication 2001-83524

### DISCLOSURE OF THE INVENTION

### Problems to be Solved by the Invention

The invention provides a method of producing a liquid crystal display device, which comprises a step of ejecting a droplet of a spacer particle dispersion with an ink-jet apparatus, depositing the droplet at a prescribed position on a substrate, then drying the droplet, and thereby arranging the spacer particle on the substrate, the spacer particle dispersion comprising a spacer particle, an adhesive component and a solvent, the spacer particle after the drying being arranged in a narrower region than the diameter of the droplet of the spacer particle dispersion deposited on the substrate.

Further, the invention provides a spacer particle dispersion comprising spacer particles, an adhesive component, and a solvent; which is to be used for the method of producing a liquid crystal display device of the invention.

The invention provides a spacer particle dispersion, which contains a spacer particle, an adhesive component and a solvent, the adhesive component being a mixture of a copolymer (A) having a repeating unit represented by the following general formula (1) and a repeating unit represented by the following general formula (2), a content of the repeating unit represented by the general formula (1) being 5 to 90% by mole and a content of the repeating unit represented by the general formula (2) being 10 to 95% by mole, and at least one kind of polyvalent compound (B) selected from the group consisting of polycarboxylic anhydride, polycarboxylic acid, aromatic polyphenol and aromatic polyamine:

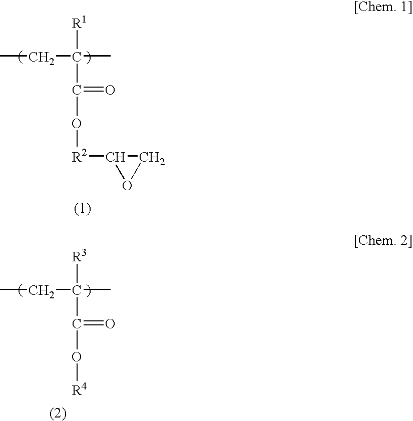

(in the formula, R¹ and R³ independently represent hydrogen atom or methyl group; R² represents an alkyl group having 1 to 8 carbon atoms; R⁴ represents an alkyl group having 1 to 12 carbon atoms, a cycloalkyl group having 5 to 12 carbon atoms, or an aromatic group; and the cycloalkyl group and aromatic group may have a substituent group).

Further, the invention provides A spacer particle dispersion, which contains a spacer particle, an adhesive component and a solvent, the adhesive component being a copolymer having a repeating unit represented by the following general formula (1), a repeating unit represented by the following general formula (2), a repeating unit derived from an unsaturated carboxylic acid and/or an unsaturated carboxylic anhydride, and a content of the repeating unit represented by the general formula (1) being 1 to 70% by mole, a content of the repeating unit represented by the general formula (2) being 10 to 98% by mole, and a content of the repeating unit derived from an unsaturated carboxylic acid and/or an unsaturated carboxylic anhydride being 1 to 70% by mole:

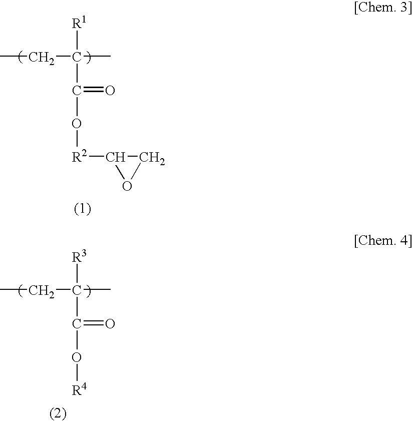

(in the formula, R¹ and R³ independently represent hydrogen atom or methyl group; R² represents an alkyl group having 1 to 8 carbon atoms; R⁴ represents an alkyl group having 1 to 12 carbon atoms, a cycloalkyl group having 5 to 12 carbon atoms, or an aromatic group; and the cycloalkyl group and aromatic group may have a substituent group).

Hereinafter, the invention will be described in detail.

A method of producing a liquid crystal display device of the invention ejects droplets of a spacer particle dispersion with an ink-jet apparatus, depositing droplets of a spacer particle dispersion at prescribed positions on a substrate, then drying the droplets, and thereby arranging the spacer particles on the substrate.

The spacer particle dispersion comprises spacer particles, an adhesive component, and a solvent. The spacer particle dispersion to be used for the method of producing a liquid crystal display device of the invention is also included in the invention.

The above-mentioned spacer particles are not particularly limited and may be inorganic type particles such as silica particle and organic type particles such as organic polymer particles. Organic type particles are especially preferable among them, since they have proper hardness not to scratch an alignment layer formed on a substrate of a liquid crystal display device, are suitable to easily follow the alteration of thickness due to thermal expansion and thermal shrinkage, and relatively scarcely move in the insides of cells.

The above-mentioned organic type particles are not particularly limited; however, in terms of the easiness for proper adjustment of strength and the like, a copolymer of monofunctional monomers and polyfunctional monomers is preferable.

The above-mentioned monofunctional monomers are not particularly limited and examples are styrene derivatives such as styrene, α-methylstyrene, p-methylstyrene, p-chlorostyrene, and chloromethylstyrene; vinyl chloride; vinyl esters such as vinyl acetate and vinyl propionate; unsaturated nitrites such as acrylonitrile; and (meth)acrylic acid ester derivatives such as methyl (meth)acrylate, ethyl(meth)acrylate, butyl(meth)acrylate, 2-ethylhexyl(meth)acrylate, stearyl(meth)acrylate, ethylene glycol (meth)acrylate, trifluoroethyl (meth)acrylate, pentafluoropropyl(meth)acrylate, and cyclohexyl(meth)acrylate. These monofunctional monomers may be used alone or two or more of them may be used in combination.

Examples of the above-mentioned polyfunctional monomers are divinylbenzene, 1,6-hexanediol di(meth)acrylate, trimethylolpropane tri(meth)acrylate, tetramethylolmethane tri(meth)acrylate, tetramethylolpropane tetra(meth)acrylate, diallyl phthalate and its isomers, triallyl isocyanurate and its derivatives, trimethylolpropane tri(meth)acrylate and its derivatives, pentaerythritol tri(meth)acrylate, pentaerythritol tetra(meth)acrylate, dipentaerythritol hexa(meth)acrylate, polyethylene glycol di(meth)acrylate such as ethylene glycol di(meth)acrylate, polypropylene glycol di(meth)acrylate such as propylene glycol di(meth)acrylate, polytetramethylene glycol di(meth)acrylate, neopentyl glycol di(meth)acrylate, 1,3-butylene glycol di(meth)acrylate, 2,2-bis[4-(methacryloxypolyethoxy)phenyl]propane di(meth)acrylate such as 2,2-bis[4-(methacryloxyethoxy)phenyl]propane di(meth)acrylate, 2,2-hydrogenated bis[4-(acryloxypolyethoxy)phenyl]propane di(meth)acrylate, and 2,2-bis[4-(acryloxyethoxypolypropoxy)phenyl]propane di(meth)acrylate. These polyfunctional monomers may be used alone or two or more of them may be used in combination.

Further, the above-mentioned monofunctional monomers or polyfunctional monomers may be those having hydrophilic groups. The above-mentioned hydrophilic groups are not particularly limited and examples are a hydroxyl group, a carboxyl group, a sulfonyl group, a phosphonyl group, an amino group, an amide group, an ether group, thiol group, and a thioether group.

The above-mentioned hydrophilic group-containing monomers are not particularly limited and examples are hydroxyl group-containing monomers such as 2-hydroxyethyl (meth)acrylate, 1,4-hydroxybutyl(meth)acrylate, (poly)caprolactone-modified hydroxyethyl(meth)acrylate, allyl alcohol, and glycerin monoallyl ether; acrylic acid such as (meth)acrylic acid, α-ethylacrylic acid, crotonic acid, and their α- or β-alkyl derivatives; unsaturated dicarboxylic acids such as fumaric acid, maleic acid, citraconic acid, and itaconic acid; carboxyl group-containing monomers of these unsaturated dicarboxylic acids such as 2-(meth)acryloyloxyethyl monoester derivatives; monomers having sulfonyl group such as t-butylacrylamidosulfonic acid, styrenesulfonic acid, 2-acrylamido-2-methylpropanesulfonic acid; monomers having phosphonyl such as vinyl phosphate, and 2-(meth)acryloyloxyethyl phosphate; compounds having an amino group such as amines having acryloyl such as dimethylaminoethyl(meth)acrylate and diethylaminoethyl (meth)acrylate; monomers having both of hydroxyl group and ether group such as (poly)ethylene glycol (meth)acrylate and (poly)propylene glycol (meth)acrylate; monomers having ether group such as alkyl-terminated ethers of (poly)ethylene glycol (meth)acrylate, alkyl-terminated ethers of (poly)propylene glycol (meth)acrylate, and tetrahydrofurfuryl(meth)acrylate; and monomers having amido group such as (meth)acrylamide, methylol (meth)acrylamide, and vinylpyrrolidone.

A method of producing the above-mentioned organic type particles is not particularly limited and may include various kinds of polymerization methods such as a suspension polymerization method, a seed polymerization method, and a dispersion polymerization method.

Since the above-mentioned suspension polymerization method is suitable to obtain particles of polydisperse system in a relatively wide distribution of particle diameter, in the case the obtained particles are to be used as the spacer particles, the particles are subjected to classification and the method is thus preferable to be employed for obtaining various types of particles with desired particle diameters or desired particle distributions. On the other hand, since the seed polymerization and dispersion polymerization can obtain particles of monodisperse system with no need of the classification treatment, the methods are preferable to produce a large quantity of particles with a specified particle diameter.

A polymerization initiator to be used in the above-mentioned suspension polymerization method, seed polymerization method, and suspension polymerization method is not particularly limited and examples are organic peroxides such as benzoyl peroxide, lauroyl peroxide, o-chlorobenzoyl peroxide, o-methoxybenzoyl peroxide, 3,5,5-trimethylhexanoyl peroxide, tert-butylperoxy-2-ethylhexanoate, and di-tert-butyl peroxide; and azo type compounds such as azobisisobutyronitrile, azobiscyclohexacarbonitrile, and azobis(2,4-dimethylvaleronitrile).

The above-mentioned spacer particles may have a surface treatment layer in order to improve the dispersibility in the spacer particle dispersion, improve the affinity with the adhesive component, and provide adhesiveness to the spacer particles themselves. For example, it is possible to physically stick and/or chemically bond a thermoplastic resin layer on the surfaces of the spacer particles. The above-mentioned surface treatment layer may be formed by evenly or partially coating the spacer particles.

A method for forming the surface treatment layer on the spacer particles may include, for example, a method for precipitating a resin on the spacer particle surfaces for modification as disclosed in Japanese Kokai Publication Hei-1-247154; methods for causing reaction of a compound with a functional group on the spacer particle surfaces for modification as disclosed in Japanese Kokai Publication Hei-9-113915 and Japanese Kokai Publication Hei-7-300587, and methods for carrying out graft polymerization on the spacer particle surfaces for surface modification as disclosed in Japanese Kokai Publication Hei-11-223821 and Japanese Patent Application 2002-102848.

Among them, since a problem of separation of the surface treatment layer in cells and elution of it in the liquid crystal of the liquid crystal display device scarcely occurs, the method for forming a surface layer chemically bonded to the spacer particle surfaces is preferable and for example, the method of carrying out graft polymerization as described in Japanese Kokai Publication Hei-9-113915 is preferable. In the method of carrying out graft polymerization, a reaction of an oxidizing agent on the spacer particles having a reductive group on the surfaces is caused to generate a radical on the surfaces of the spacer particles and graft polymerization is carried out. If the graft polymerization is carried out, the density of the surface layer of the spacer particles can be increased and the surface layer with a sufficient thickness can be formed. Accordingly, the graft polymerized spacer particles are excellent in the dispersibility in the spacer particle dispersion as described later. Further, the spacer particles are excellent in the adhesiveness on the substrate in the case the spacer particle dispersion is ejected to the substrate. In the case of carrying out charging treatment in this method, at the time of graft polymerization, it is preferable to use a monomer having a hydrophilic group as a monomer in combination. Further, if the monomer to be used is properly selected, it is effective to avoid disturbance of the alignment of the liquid crystal in the liquid crystal display.

The above-mentioned spacer particles may be subjected to chargeable treatment. If the spacer particles are chargeable, the dispersibility and the dispersion stability of the spacer particles in the spacer particle dispersion can be increased and the spacer particles tend to easily gather in the peripheries of wiring parts (step) based on the electrophoresis effect at the time of spraying.

In this description, the chargeable treatment means treatment for giving potential to the spacer particles in the spacer particle dispersion and the potential (electric charge) can be measured by a conventional method using a zeta potential measurement apparatus.

A method for carrying out the above-mentioned chargeable treatment for the spacer particles is not particularly limited and may include, for example, a method of adding a charge control agent to the spacer particles; a method of carrying out surface treatment for giving chargeability to the spacer particles; and a method for producing the spacer particles using monomers including a monomer easy to be charged as starting materials.

The method of adding a charge control agent to the spacer particles may include a method of adding the agent to the spacer particles by carrying out polymerization in the presence of a charge control agent at the time of polymerization; a method of adding the agent to the spacer particles by copolymerizing a monomer composing the spacer particles with a charge control agent having a functional group copolymerizable with the monomer at the time of polymerization of the spacer particles; a method of adding the agent in the surface modification layer by carrying out copolymerization of a charge control agent having a functional group copolymerizable with a monomer to be used for surface modification at time of surface modification of the spacer particles; and a method of adding the agent to the surface by causing reaction of charged particles having a functional group repulsive to the surface modification layer or the surface functional group of the spacer particles.

The above-mentioned charge control agent is not particularly limited and examples are urea derivatives, metal-containing salicylic acid compounds, quaternary ammoniums, Calixarene, silicon compounds, styrene-acrylic acid copolymers, styrene-methacrylic acid copolymers, styrene-acryl-sulfonic acid copolymers, non-metal carboxylic acid compounds, Negrosine and its denatured products by fatty acid metal salts, tributylbenzylammonium-1-hydroxy-4-naphthosulfonic acid salts, quaternary ammonium salts such as tetrabutylammonium tetrafluoroborate and oniums such as phosphonium salts, that is, their analogous compounds, and their lake pigments, triphenylmethane dyes and their lake pigments (agents for lake pigment may include phosphotungstic acid, phosphomolybdic acid, phosphotungstomolybdic acid, tannic acid, lauric acid, gallic acid, ferricyanide, ferrocyanide and the like), higher fatty acid metal salts, diorganotin oxides such as dibutyltin oxide, dioctyl tin oxide, and dicyclohexyltin oxide, and diorganotin borates such as dibutyltin borate, dioctyltin borate, and dicyclohexyltin borate. These charge control agents may be used alone and two or more of them may be used in combination.

The polarity of the spacer particles containing the above-mentioned charge control agent may be set by properly selecting a proper charge control agent among the above-mentioned charge control agent. That is, the spacer particles can be changed to bear positive charge or negative charge in relation to the ambient environments.

In the above-mentioned method of producing the spacer particles using the monomers including a monomer easy to be charged as starting materials, the monomer easy to be charged are monomers having a hydrophilic functional group among the above-mentioned exemplified monomers.

The above-mentioned spacer particles may be colored to improve the contrast of display elements. The colored spacer particles may be particles treated with carbon black, dispersion dyes, acidic dyes, basic dyes, and metal oxides and colored particles obtained by forming an organic film on the surfaces of particles, decomposing and carbonizing the film at a high temperature. In this case, if the material itself for forming the particles has a color, the particles may be used as they are with no need of coloration.

The particle diameter of the above-mentioned spacer particles may be selected properly in accordance with the type of the liquid crystal display elements and it is preferably 1 μm in the lower limit and 20 μm in the upper limit. If it is narrower than 1 μm, the mutually opposed substrates are brought into contact with each other and the spacer particles do not function well and if it is wider than 20 μm, the spacer particles tend to come out of the light-blocking regions on the substrate where the spacer particles have to be arranged and the distance of the mutually opposed substrates becomes wide and it results in impossibility to sufficiently meet the recent requirement for compactness to the liquid crystal display elements.

The above-mentioned spacer particles is preferable to have 2000 MPa in the lower limit and 15000 MPa in the upper limit of compressive elastic modulus (10% K value) at the time of 10% deformation of the diameter of the particles. If it is lower than 2000 MPa, the spacer particles are deformed by pressing pressure at the time of assembling the liquid crystal display elements and that makes it impossible to obtain a proper gap, and if it exceeds 15000 MPa, the spacer particles may possibly scratch the alignment layer on the substrate and cause display abnormality in the case of assembling the spacer particles in the liquid crystal display elements.

The above-mentioned 10% K value can be calculated from a load for causing 10% strain of particles on a smooth end face of a column made of diamond and having 50 pm diameter by a micro compression tester (PCT-200, manufactured by Shimadzu Corporation).

The above-mentioned spacer particles are preferable to be dispersed in a single particle state in the spacer particle dispersion. If there are agglomerates in the dispersion, not only the ejecting precision is lowered but also clogging of a nozzle of an ink-jet apparatus may be caused in an extreme cases.

The above-mentioned adhesive component exhibits the cohesive power during the process of drying of the spacer particle dispersion deposited on the substrate and takes a role of firmly fixing the spacer particles on the substrate.

The above-mentioned adhesive component may be dissolved or dispersed. In the case the adhesive component is dispersed, the dispersion diameter is preferable to be not larger than 10% of the particle diameter of the spacer particles.

The above-mentioned adhesive component is preferable to be very soft, that is, the adhesive component is preferable to have a low elastic modulus (after curing) as compared with the spacer particles, so that the adhesive component does not deteriorate the gap maintaining function of the spacer particles.

Examples to be used as the adhesive component are curable resins such as thermoplastic resins with a glass transition temperature of 150° C. or lower; resins hardened by volatilization of a solvent; thermosetting resins; photosetting resins, and photo-thermosetting resins.

The thermoplastic resins with a glass transition temperature of 150° C. or lower can be melted or softened by heat at the time of heat bonding of the substrate and exhibit cohesive power to firmly fix the spacer particles on the substrate.

The above-mentioned thermoplastic resins with a glass transition temperature of 150° C. or lower are preferable not to be dissolved in an alignment layer solvent or not dissolve the alignment layer. In the case a thermoplastic resin which is dissolved in the alignment layer solvent and dissolves the alignment layer is used, it may possibly cause liquid crystal contamination.

The thermoplastic resin which has a glass transition temperature of 150° C. or lower and which is not dissolved in an alignment layer solvent or does not dissolve the alignment layer is not particularly limited and examples are poly(meth)acrylic resins, polyurethane resins, polyester resins, epoxy resins, polyamide resins, polyimide resins, cellulose resins; polyolefin resins such as polybutadiene and polybutylene; polyvinyl resins poly (vinyl chloride), poly(vinyl acetate) and polystyrene; polyacrylic resins, polycarbonate resins, and poly acetal resins. Further, copolymers such as styrene-butadiene-styrene resins made to have a glass transition temperature of 150° C. or lower by adjusting the monomer components may be employed.

The resins to be hardened by volatilization of the solvent of the above-mentioned spacer particle dispersion are kept in the state that the resins are not hardened while being dispersed in the spacer particle dispersion and hardened by volatilization of the solvent and firmly fix the spacer particles on the substrate after the spacer particle dispersion is ejected to the substrate.

Examples of such a resin are acrylic adhesives containing block isocyanate in the case the solvent is water-based ones.

The above-mentioned curable resins such as thermosetting resins; photosetting resins, and photo-thermosetting resins are kept in the state that the resins are not hardened while being dispersed in the spacer particle dispersion and hardened by heating and/or radiating light and firmly fix the spacer particles on the substrate after the spacer particle dispersion is ejected to the substrate.

The above-mentioned thermosetting resins are not particularly limited and may include phenol resins, melamine resins, unsaturated polyester resins, epoxy resins, and maleimide resins. Further, examples to be usable for the resins may include alkoxymethylacrylamide whose reaction is started by heating; resins having a reactive functional group whose crosslinking reaction (urethane reaction and epoxy crosslinking reaction) is caused by previously adding a crosslinking agent and heating; and monomer mixtures (e.g., mixtures of oligomers having an epoxy group in the side chains and initiators) to form crosslinkable polymers by reaction caused by heating.

The above-mentioned photosetting resins are not particularly limited and examples usable as the resins may include mixtures of initiators for starting reaction by light and various kinds of monomers (e.g., mixtures of photo-radical initiators and acrylic monomer binders and mixtures of photo-acid generation initiators and epoxy oligomers); polymers having a photo-crosslinkable group (e.g. cinnamic acid type compounds); and azide compounds.

In the method of producing the liquid crystal display device of the invention, the above-mentioned adhesive component is preferably a mixture of a copolymer (A) having a repeating unit represented by the following general formula (1) and a repeating unit represented by the following general formula (2), a content of the repeating unit represented by the general formula (1) being 5 to 90% by mole and a content of the repeating unit represented by the general formula (2) being 10 to 95% by mole, and at least one kind of polyvalent compound (B) selected from the group consisting of polycarboxylic anhydride, polycarboxylic acid, aromatic polyphenol and aromatic polyamine. In this case, the adhesive component which is a mixture of the above-mentioned copolymer (A) and the polyvalent compound (B) may be referred to as “adhesive component of a mixture”.

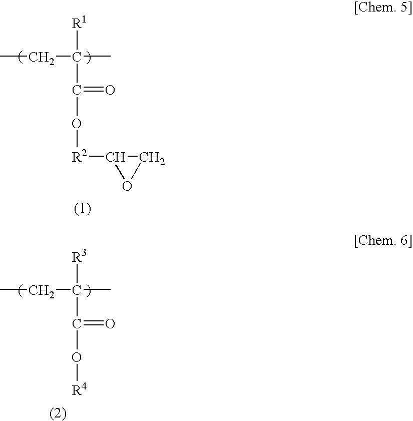

in the formula, R¹ and R³ independently represent hydrogen atom or methyl group; R² represents an alkyl group having 1 to 8 carbon atoms; R⁴ represents an alkyl group having 1 to 12 carbon atoms, a cycloalkyl group having 5 to 12 carbon atoms, or an aromatic group; and the cycloalkyl group and aromatic group may have a substituent group.

If the above-mentioned adhesive component is the above-mentioned adhesive component of a mixture, no gelation of the above-mentioned spacer particle dispersion by promotion of the crosslinking reaction as observed in the case of common acid-epoxy copolymers is caused and the epoxy group content in the adhesive component of a mixture can be increased. Further, the spacer particle dispersion containing the adhesive component of a mixture makes it possible to spray the spacer particles by an ink-jet apparatus since high concentration and low viscosity can be accomplished and further the adhesive component of a mixture sprayed together with the spacer particles on the substrate has a high capability to fix the spacer particles on the substrate and gives a high crosslinking density after curing and accordingly a gap maintaining material excellent in durability in various fields can be formed. Further, heat resistance can be improved. That is, addition of the above-mentioned adhesive component of a mixture as the adhesive component makes it possible to precisely and firmly arrange the spacer particles at prescribed positions on the substrate by depositing droplets of the spacer particle dispersion at the prescribed positions on a substrate by ejecting the spacer particle dispersion with an ink-jet apparatus and drying the droplets.

The spacer particle dispersion containing the spacer particles, the above-mentioned adhesive component of a mixture and the solvent also constitutes the invention.

The copolymer (A) contained in the above-mentioned adhesive component of a mixture contains the repeating unit represented by the above-mentioned general formula (1) (hereinafter, also referred to as repeating unit (a1)) and the repeating unit represented by the above-mentioned general formula (2) ((hereinafter, also referred to as repeating unit (a2)).

Examples of the monomer to be the above-mentioned repeating unit (a1) are epoxy group-containing radical polymerizable compounds.

The above-mentioned epoxy group-containing radical polymerizable compounds are not particularly limited and examples are glycidyl acrylate, glycidyl methacrylate, glycidyl α-ethylacrylate, glycidyl α-n-propylacrylate, glycidyl α-n-butylacrylate, 3,4-epoxybutyl acrylate, 3,4-epxoybutyl methacrylate, 6,7-epoxyheptyl acrylate, 6,7-epoxyheptyl methacrylate, and 6,7-epoxyheptyl α-ethylacrylate. Among them, glycidyl acrylate and glycidyl methacrylate are preferably usable. These compounds may be used alone or two or more of them may be used in combination.

In the above-mentioned copolymer (A), the content of the above-mentioned repeating unit (a1) is 5% by mole in the lower limit and 90% by mole in the upper limit. If it is less than 5% by mole, the heat resistance and chemical resistance of the adhesive component of a mixture are lowered and if it exceeds 90% by mole, gelation of the spacer particle dispersion containing the adhesive component of a mixture is caused. The lower limit is preferably 10% by mole and the upper limit is preferably 70% by mole.

Examples of the monomer to be the above-mentioned repeating unit (a2) are mono olefin type unsaturated compounds.

The above-mentioned mono olefin type unsaturated compounds are not particularly limited and examples are methacrylic acid alkyl esters such as methyl methacrylate, ethyl methacrylate, n-butyl methacrylate, sec-butyl methacrylate, and tert-butyl methacrylate; acrylic acid alkyl esters such as methyl acrylate, n-butyl acrylate, and isopropyl acrylate; methacrylic acid cycloalkyl esters such as cyclohexyl methacrylate, 2-methylcyclohexyl methacrylate, dicyclopentanyloxyethyl methacrylate, and isobornyl methacrylate; acrylic acid cycloalkyl esters such as cyclohexyl acrylate, 2-methylcyclohexyl acrylate, dicyclopentanyl acrylate, dicyclopentaoxyethyl acrylate, and isobornyl acrylate; methacrylic acid aryl esters such as phenyl methacrylate and benzyl methacrylate; acrylic acid aryl esters such as phenyl acrylate and benzyl acrylate; dicarboxylic acid diesters such as diethyl maleate, diethyl fumarate, and diethyl itaconate; hydroxyalkyl esters such as 2-hydroxyethyl methacrylate and 2-hydroxypropyl methacrylate; styrene, α-methylstyrene, m-methylstyrene, p-methylstyrene, vinyltoluene, p-methoxystyrene, acrylonitrile, methacrylonitrile, vinyl chloride, vinylidene chloride, acrylamide, methacrylamide, and vinyl acetate. Among them, methacrylic acid alkyl esters, acrylic acid alkyl esters, styrene, dicyclopentanyl methacrylate, p-methoxystyrene preferably are usable. These compounds may be used alone or two or more of them may be used in combination.

In the above-mentioned copolymer (A), the content of the above-mentioned repeating unit (a2) is 10% by mole in the lower limit and 95% by mole in the upper limit. If it is less than 10% by mole, gelation of the spacer particle dispersion containing the adhesive component of a mixture is caused, and if it exceeds 95% by mole, the heat resistance and chemical resistance of the adhesive component of a mixture are lowered. The lower limit is preferably 30% by mole and the upper limit is preferably 90% by mole.

Herein, in the case of producing the copolymer of a monomer for forming the above-mentioned repeating unit (a1) and a monomer for forming the above-mentioned repeating unit (a2), the epoxy group and the carboxylic acid group are reacted and crosslinked to possibly cause gelation of the polymer system.

However, since the spacer particle dispersion containing the above-mentioned adhesive component of a mixture contains the above-mentioned polyvalent compound (B) as the adhesive component of a mixture, no gelation due to the promotion of the crosslinking reaction observed in the case of a common acid-epoxy copolymer is caused and the epoxy group content of the adhesive component of a mixture can be increased. Further, since the spacer particle dispersion containing the adhesive component of a mixture can have a high concentration and a low viscosity, spraying of the spacer particles by an ink-jet apparatus is made possible, and the adhesive component of a mixture sprayed together with the spacer particles on the substrate has high capability of firmly fixing the spacer particles on the substrate and further giving high crosslinking density after curing, so that a gap maintaining material excellently durable in various fields can be formed. Heat resistance is also improved.

A method for producing the copolymer (A) containing the repeating unit (a1) and the repeating unit (a2) is not particularly limited and may include conventionally known methods of copolymerizing a monomer for forming the above-mentioned repeating unit (a1) and a monomer for forming the above-mentioned repeating unit (a2) in a conventionally known solvent in a manner that their ratio is in the above-mentioned range.

The above-mentioned polyvalent compound (B) has a function as a curing agent for the above-mentioned copolymer (A) and examples of the polyvalent compound (B) may be at least one kind of compounds selected from the group consisting of polycarboxylic anhydrides, polycarboxylic acids, aromatic polyphenols, and aromatic polyamines.

Examples of polycarboxylic anhydrides are aliphatic dicarboxylic anhydrides such as itaconic anhydride, succinic anhydride, citraconic anhydride, dodecenylsuccinic anhydride, tricarballylic anhydride, maleic anhydride, hexahydrophthalic anhydride, methyltetrahydrophthalic anhydride, and himic anhydride; alicyclic polycarboxylic acid dianhydrides such as 1,2,3,4-butanetetracarboxylic acid dianhydride and cyclopentanetetracarboxylic acid dianhydride; aromatic polycarboxylic anhydrides such as phthalic anhydride, pyromellitic anhydride, trimellitic anhydride, and benzophenonetetracarboxylic anhydride; and ester group-containing acid anhydrides such as ethylene glycol bistrimellitic anhydride and glycerin tristrimellitic anhydride. Particularly, the aromatic polycarboxylic anhydrides are preferable in terms of heat resistance.

Further, commercialized colorless epoxy resin curing agents composed of acid anhydrides are also preferably usable. Examples of the commercialized colorless epoxy resin curing agents composed of acid anhydrides are Adeka Hardener EH 700 (manufactured by ADEKA COOPERATION), Rikacid HH, Rikacid MH-700 (manufactured by New Japan Chemical Co., Ltd.), Epikure 126, Epikure YH-306, Epikure DX-126 (Yuka Shell Epoxy K. K.), and Epiclon B-4400 (manufactured by Dainippon Ink and Chemicals, Inc.). Examples of the polycarboxylic acids are aliphatic polycarboxylic acids such as succinic acid, glutaric acid, adipic acid, butanetetracarboxylic acid, maleic acid, and itaconic acid; alicyclic carboxylic acids such as hexahydrophthalic acid, 1,2-cyclohexanecarboxylic acid, 1,2,4-cyclohexanetricarboxylic acid, and cyclopentanetetracarboxylic acid; and aromatic polycarboxylic acids such as phthalic acid, isophthalic acid, terephthalic acid, trimellitic acid, pyromellitic acid, and 1,2,5,8-naphthalenetetracarboxilic acid. Particularly, the aromatic polycarboxylic acids are preferably in terms of reactivity and heat resistance.

These curing agents may be used alone or two or more of them may be used in combination.

With respect to the adhesive component of a mixture, the mixing ratio of the above-mentioned copolymer (A) and polyvalent compound (B) is not particularly limited, however the amount of the polyvalent compound (B) is preferably 1 part by weight in the lower limit and 100 parts by weight in the upper limit to 100 parts by weight of the copolymer (A). If it is less than 1 part by weight, the heat resistance and the chemical resistance of a cured product may deteriorate, and on the other hand, if it is more than 100 parts by weight, a large quantity of the un-reacted curing agent remains and it may possibly result in decrease of heat resistance of a cured product and deterioration of anti-contamination property of the liquid crystal. The lower limit is more preferably 3 parts by weight and the upper limit is more preferably 50 parts by weight.

With respect to the spacer particle dispersion containing the adhesive component of a mixture, components other than the above-mentioned copolymer (A) and polyvalent compound (B) may be added and for example, additives such as curing promoters and adhesive aids may be added in accordance with the necessity.

The above-mentioned curing promoters are generally those which promote the reaction of epoxy group of the above-mentioned copolymer (A) and the polyvalent compound (B) and increase the crosslinking density. Preferably compounds are, for example, those which have hetero-ring structures containing secondary nitrogen atoms or tertiary nitrogen atoms and may include pyrroles, imidazoles, pyrazoles, pyridines, pyrazines, pyrimidines, indoles, indazoles, benzimidazoles, and isocyanuric acids. Practical examples are imidazole derivatives such as 2-methylimidazole, 2-ethyl-4-methylimidazole, 2-heptadecylimidazole, 4-methyl-2-phenylimidazole, 1-benzyl-2-methylimidazole, 2-ethyl-4-methyl-1-(2′-cyanoethyl)imidazole, 2-ethyl-4-methyl-1-[2′-(3″,5″-diaminotriazinyl)ethyl]imidazole, and benzimidazoles, and among them, 2-ethyl-4-methylimidazole, 4-methyl-2-phenylimidazole, and 1-benzyl-2-methylimidazole are preferable.

These curing promoters may be used alone or two or more of them may be used in combination.

In the case the above-mentioned curing promoter is added, the addition amount is not particularly limited, however it is preferably 0.01 parts by weight in the lower limit and 2 parts by weight in the upper limit to 100 parts by weight of the above-mentioned copolymer (A). If it is less than 0.01 parts by weight, the effect of the curing promoter addition is scarcely caused and if it exceeds 2 parts by weight, the un-reacted curing promoter remains and it may possibly result in decrease of heat resistance of a cured product and deterioration of anti-contamination property of the liquid crystal.

Further, in the method of producing the liquid crystal display device of the invention, it is preferable that the above-mentioned adhesive component is a copolymer having a repeating unit represented by the following general formula (1), a repeating unit represented by the following general formula (2), a repeating unit derived from an unsaturated carboxylic acid and/or an unsaturated carboxylic anhydride, and a content of the repeating unit represented by the general formula (1) being 1 to 70% by mole, a content of the repeating unit represented by the general formula (2) being 10 to 98% by mole, and a content of the repeating unit derived from an unsaturated carboxylic acid and/or an unsaturated carboxylic anhydride being 1 to 70% by mole. Hereinafter, the adhesive component which is a copolymer having a repeating unit represented by the following general formula (1), a repeating unit represented by the following general formula (2), and a repeating unit derived from an unsaturated carboxylic acid and/or an unsaturated carboxylic anhydride is referred to as “adhesive component of a copolymer.

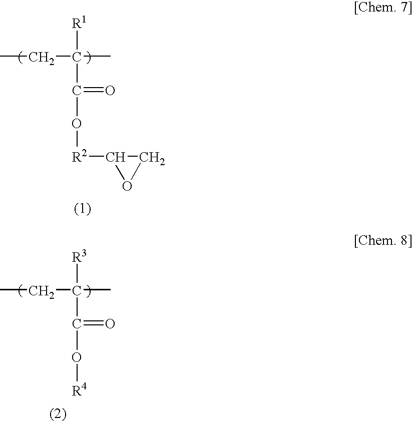

in the formula, R¹ and R³ independently represent hydrogen atom or methyl group; R² represents an alkyl group having 1 to 8 carbon atoms; R⁴ represents an alkyl group having 1 to 12 carbon atoms, a cycloalkyl group having 5 to 12 carbon atoms, or an aromatic group; and the cycloalkyl group and aromatic group may have a substituent group.

If the above-mentioned adhesive component is the above-mentioned adhesive component of a copolymer, since the above-mentioned adhesive component of a copolymer contains the repeating unit derived from unsaturated carboxylic acid and/or unsaturated carboxylic anhydride, the spacer particle dispersion becomes difficult to cause gelation in the polymer system due to the reaction of the epoxy group and the carboxyl group contained in the adhesive component of a copolymer and is excellent in the storage stability. Further, since the above-mentioned adhesive component of a copolymer is easily cured only by heating, it is no need to use a specific curing agent and it is made possible to obtain a gap maintaining material of the liquid crystal display device which extremely scarcely contains contaminants to the alignment layer on the substrate and the liquid crystal. That is, addition of the adhesive component of a copolymer as the adhesive component makes it possible to precisely and firmly arrange the spacer particles on prescribed positions on the substrate using an ink-jet apparatus and in the case of using the adhesive component for the production of the liquid crystal display device, the alignment layer and the liquid crystal are scarcely contaminated.

The spacer particle dispersion containing the spacer particles, the above-mentioned adhesive component of a copolymer, and a solvent also constitutes the invention.

The adhesive component of a copolymer is a copolymer having a repeating unit represented by the above-mentioned general formula (1) (hereinafter, also referred to as repeating unit (a)), a repeating unit represented by the above-mentioned general formula (2) (hereinafter, also referred to as repeating unit (b)), and a repeating unit derived from an unsaturated carboxylic acid and/or an unsaturated carboxylic anhydride (hereinafter, also referred to as repeating unit (c)).

A monomer for forming the above-mentioned repeating unit (a) is not particularly limited and may be epoxy group-containing radical polymerizable compounds same as the exemplified compounds for the repeating unit (a1) of the above-mentioned adhesive component of a mixture.

In the above-mentioned copolymer, the content of the above-mentioned repeating unit (a) is 1% by mole in the lower limit and 70% by mole in the upper limit. If it is less than 1% by mole, the heat resistance and chemical resistance of the adhesive component of a copolymer may be lowered and if it exceeds 70% by mole, the spacer particle dispersion containing the adhesive component of a copolymer may cause gelation. The lower limit is preferably 5% by mole and the upper limit is preferably 40% by mole. The upper limit is more preferably 20% by mole.

A monomer for forming the above-mentioned repeating unit (b) is not particularly limited and may be mono olefin type unsaturated compounds same as the exemplified compounds for the repeating unit (a2) of the above-mentioned adhesive component of a mixture.

In the above-mentioned copolymer, the content of the above-mentioned repeating unit (b) is 10% by mole in the lower limit and 98% by mole in the upper limit. If it is less than 10% by mole, the spacer particle dispersion containing the adhesive component of a copolymer may cause gelation and if it exceeds 98% by mole, the heat resistance and chemical resistance of the adhesive component of a copolymer may be lowered. The lower limit is preferably 20% by mole and the upper limit is preferably 90% by mole.

A monomer for forming the above-mentioned repeating unit (c) may include monocarboxylic acids such as acrylic acid, methacrylic acid, and crotonic acid; dicarboxylic acids such as maleic acid, fumaric acid, citraconic acid, mesaconic acid, and itaconic acid; and anhydrides of these acids. Among them, acrylic acid, methacrylic acid, and maleic anhydride preferably are usable. These compounds may be used alone or two or more of them may be used in combination.

In the above-mentioned copolymer, the content of the above-mentioned repeating unit (c) is 1% by mole in the lower limit and 70% by mole in the upper limit. If it is less than 1% by mole, the heat resistance and chemical resistance of the adhesive component of a copolymer may be lowered and if it exceeds 70% by mole, the spacer particle dispersion containing the adhesive component of a copolymer may cause gelation. The lower limit is preferably 5% by mole and the upper limit is preferably 40% by mole. The upper limit is more preferably 20% by mole.

Herein, if the copolymer is produced only from the monomer for forming the above-mentioned repeating unit (a) and the monomer for forming the above-mentioned repeating unit (b), the epoxy group and the carboxylic acid group are reacted and crosslinked to cause gelation of the polymer system.

However, the adhesive component of a copolymer, since the monomer for forming the above-mentioned repeating unit (c) is copolymerized with the monomer for forming the above-mentioned repeating unit (a) and the monomer for forming the above-mentioned repeating unit (b) in the above-mentioned range, the gelation of the polymer system by the reaction of the epoxy group and the carboxylic acid group is hardly caused and the adhesive component of a copolymer is provided with improved storage stability.

Further, since the above-mentioned adhesive component of a copolymer is easily cured only by heating, it is no need for the spacer particle dispersion containing the adhesive component of a copolymer to use a specific curing agent and it is made possible to obtain a gap maintaining material of the liquid crystal display device which extremely scarcely contains contaminants to the alignment layer on the substrate and the liquid crystal.

Examples to be used as the above-mentioned solvent are various kinds of solvents in liquid phase at a temperature at which the dispersion is ejected out of a head of an ink-jet apparatus and may be water-soluble or hydrophilic solvents and organic solvents.

The solvent is not particularly limited and may include water and also monoalcohols such as ethanol, n-propanol, 2-propanol, 1-butanol, 2-butanol, 1-hexanol, 1-methoxy-2-propanol, furfuryl alcohol, and tetrahydrofurfuryl alcohol; ethylene glycol polymers such as ethylene glycol, diethylene-glycol, triethylene glycol, and tetraethylene glycol; propylene glycol polymers such as propylene glycol, dipropylene glycol, tripropylene glycol, and tetrapropylene glycol; lower monoalkyl ethers of glycol such as monomethyl ether, monoethyl ether, monoisopropyl ether, monopropyl ether, and monobutyl ether; lower dialkyl ethers such as dimethyl ether, diethyl ether, diisopropyl ether, and dipropyl ether; alkyl esters such as monoacetate and diacetate; diols such as 1,3-propanediol, 1,2-butandiol, 1,3-butanediol, 1,4-butanediol, 3-methyl-1,5-pentanediol, 3-hexene-2,5-diol, 1,5-pentanediol, 2,4-pentanediol, 2-methyl-2,4-pentanediol, 2,5-hexanediol, 1,6-hexanediol, and neopentyl glycol; ether derivatives of diols; acetate derivatives of diols; polyhydric alcohols or their ether derivatives and ester derivatives (in the case of glycerin, monoacetin, diacetin, triacetin, and the like) such as glycerin, 1,2,4-butanetriol, 1,2,6-hexanetriol, 1,2,5-pentanetriol, trimethylolpropane, trimethylolethane, and pentaerythritol; acetate derivatives; dimethyl sulfoxide, thiodiglycol, N-methyl-2-pyrrolidone, N-vinyl-2-pyrrolidone, γ-butyrolactone, 1,3-dimethyl-2-imidazolidine, sulfolan, formamide, N,N-dimethylformamide, N,N-diethylformamide, N-methylformamide, acetamide, N-methylacetamide, α-terpineol, ethylene carbonate, propylene carbonate, bis-β-hydroxyethylsulfone, bis-β-hydroxyethylurea, N,N-diethylethanolamine, abietinol, dieacetone alcohol, urea, ester compounds, alkyl esters such as ethylene glycol diacetate; ether esters such as diethylene glycol monoethyl ether acetate; and ester compounds such as diethyl phthalate, diethyl malonate, ethyl acetoacetate, and methyl lactate.

In order to improve the dispersibility of the spacer particles, improve the ejecting precision by controlling the physical properties such as surface tension and viscosity, and improve the mobility of the spacer particles, the above-mentioned spacer particle dispersion may contain various kinds of surfactants and viscosity adjustment agents to an extent that the purposes of the invention are not inhibited.

The above-mentioned spacer particle dispersion preferably has a spacer particle concentration of 0.01% by weight in the lower limit and 5% by weight in the upper limit. If it is lower than 0.01% by weight, the probability of containing no spacer particle in a ejected droplet is increased and if it exceeds 5% by weight, the nozzle of an ink-jet apparatus may be clogged or the number of the spacer particles in a deposited droplet may become too high to transfer (concentrate) the spacer particles during the drying process. It is more preferably 0.1% by weight in the lower limit and 2% by weight in the upper limit.

It is preferable for the spacer particle dispersion to contain a little content of non-volatile components other than the spacer particles (and the dispersed adhesive component) and more specifically, it is preferable that the ratio of the non-volatile components with a particle size smaller than 1 μm is less than 0.001% by weight in the entire spacer particle dispersion. If it exceeds 0.001% by weight, the liquid crystal and alignment layer may be contaminated and the display quality such as contrast of the liquid crystal display device may become inferior.

The above-mentioned non-volatile components include, for example, airborne dust, impurities contained in the solvent used for dispersing the spacer particles, crushed fragments of the spacer particles, and ionic compounds such as metal ions and thus include solid matter and non-spherical particulate having no shape storage property in the spacer particle dispersion.

A method for lessening the above-mentioned non-volatile components in the spacer particle dispersion may be a method involving at first removing large dust by filtering the spacer particle dispersion with a filter having a filtration diameter larger than the particle diameter of the spacer particles, settling the spacer particles by centrifugating the filtered spacer particle dispersion, obtaining the spacer particles by discarding the supernatant liquid and successively carrying out filtration, adding a solvent filtered with a filter having a filtration diameter of 1 μm to the obtained spacer particles, and dispersing the spacer particles in the solvent; a method involving obtaining spacer particles by filtration with a filter having a filtration diameter smaller than the particle diameter of the spacer particles and dispersing the spacer particles in a solvent filtered with a filter having a filtration diameter of 1 μm; and a method of using an ion adsorptive solid such as a layered silicate. These methods may be repeated.

The above-mentioned spacer particle dispersion is preferable to have 0.2 or narrower specific gravity difference between the spacer particles and the liquid portion other than the spacer particles. If it exceeds 0.2, the spacer particles may be settled or floated during the storage of the spacer particle dispersion and the number of the spacer particles in the ejected spacer particle dispersion may become uneven. If it is 0.1 or narrower, even in the case the diameter of the spacer particles is large, the spacer particles are not settled or floated for a long duration and accordingly, it is more preferable.

In the spacer particle dispersion having 0.2 or narrower specific gravity difference between the spacer particles and the liquid portion other than the spacer particles, if the spacer particles are of an organic polymer, the specific gravity of the spacer particles are usually about in a range from 1.10 to 1.20 and accordingly, it is preferable to select solvents having the specific gravity about in a range from 0.90 to 1.40, especially about from 1.00 to 1.30, in form of a mixture. Practical examples of the solvents may be properly selected from the above-exemplified solvents and in the case of using solvents alone, examples to be used are dialcohol compounds such as ethylene glycol, propanediols, e.g. propylene glycol, diethylene glycol, and butanediols, e.g. 1,4-butanediol; their alkyl esters (e.g. ethylene glycol diacetate); their ether esters (e.g. diethylene glycol monoethyl ether acetate); glycerin, its ethers, and esters (e.g. triacetin) and ester compounds such as dimethyl phthalate, diethyl phthalate, dimethyl malonate, diethyl malonate, ethyl acetoacetate, and methyl lactate.

The above-mentioned spacer particle dispersion is preferable to have 5.0 or narrower solubility parameter value difference between the surface of the spacer particles and the liquid portion other than the spacer particles. If it exceeds 5.0, dispersibility of the spacer particles in the spacer particle dispersion may be lowered and the number of the spacer particles in the ejected spacer particle dispersion may become uneven.

The above-mentioned spacer particle dispersion is preferable to have surface tension of 25 to 50 mN/m. If the surface tension is out of the range, it may become difficult to stably eject the dispersion by an ink-jet apparatus.

Further, the spacer particle dispersion is preferable to have a value calculated by subtracting the surface tension of the substrate from the surface tension value of the spacer particle dispersion in a range from −2 to 40 mN/m. If the value is less than −2 mN/m, the deposition diameter may become very large at the time of depositing the spacer particle dispersion on the substrate and if it exceeds 40 mN/m, the deposited spacer particles easily move to make precise spacer arrangement impossible in some cases.

With respect to the above-mentioned spacer particle dispersion, to satisfy the above-mentioned requirement for the surface tension, it is preferable to mix a solvent with a low boiling point and a low surface tension and a solvent with a high boiling point and a high surface tension. If solvents are selected for such a combination, since the surface tension is increased more as the deposited droplets of the spacer particle dispersion is dried more, the diameter of the droplets becomes smaller as the drying of the droplets is promoted further and thus the range of final fixation of the spacer particles can be restricted.

The above-mentioned solvent with a high boiling point and a high surface tension are preferably those having a boiling point of 150° C. or higher and a surface tension of 30 mN/m or higher (more preferably 35 mN/m or higher) and practical examples are ethylene glycol, propanediol such as propylene glycol; dialcohol compounds such as diethylene glycol, and various kinds of butanediol such as 1,4-butanediol; glycerin and its esters (monoacetin and diacetin). In the case the surface tension of the substrate is low, that is, in the case water-repelling treatment is carried out for the substrate or in the case of a substrate having an alignment layer with a low surface tension (an alignment layer to be used for a perpendicularly aligned liquid crystal), usable solvents may include esters and ethers of the above-mentioned dialcohols; ethers and triesters of glycerin; and high boiling point ester compounds such as diethyl phthalate, dimethyl malonate, diethyl malonate, ethyl acetoacetate, and ethyl lactate in addition to the above-mentioned solvents.

The above-mentioned solvent with a low boiling point and a low surface tension are those having a lower boiling point and a lower surface tension than the boiling point and the surface tension of the above-mentioned solvent with a high boiling point and a high surface tension and preferably those having a boiling point lower than 150° C. and a surface tension lower than 30 mN/m. Practical examples are various kinds of monoalcohols having 4 or less carbon atoms such as methanol, ethanol, 1-propanol, 2-propanol, 1-butanol, 2-butanol, and tert-butanol; ethylene glycol mono- or di-alkyl ethers such as ethylene glycol monomethyl ether, ethylene glycol monoethyl ether, ethylene glycol monoisopropyl ether, ethylene glycol dimethyl ether, and ethylene glycol diethyl ether; propylene glycol mono- or di-alkyl ethers such as propylene glycol monomethyl ether, propylene glycol monoethyl ether, propylene glycol monoisopropyl ether, propylene glycol dimethyl ether, and propylene glycol diethyl ether; ethers such as dioxane and tetrahydrofuran; low boiling point ester compounds such as ethyl acetate. With respect to water, the boiling point is 100° C. and the surface tension is 72.6 mN/m and accordingly water has a low boiling point and a high surface tension, however in the case a solvent with a boiling point of 150° C. or higher and a surface tension of 30 mN/m or higher (more preferably 35 mN/m or higher) is added, the aim of mixing the solvent with a low boiling point and a low surface tension and the solvent with a high boiling point and a high surface tension, that is, the aim of making the diameter of the droplets smaller as the drying is promoted further, is not inhibited and therefore water can be added.

It is especially preferable to use, as the above-mentioned solvent with a high boiling point and a high surface tension, ethylene glycol, propanediol such as propylene glycol; dialcohol compounds such as diethylene glycol, and various kinds of butanediol such as 1,4-butanediol; and glycerin and its esters (monoacetin and diacetin) and as the above-mentioned solvent with a low boiling point and a low surface tension, various kinds of monoalcohols having 4 or less carbon atoms such as methanol, ethanol, 1-propanol, 2-propanol, 1-butanol, 2-butanol, and tert-butanol in combination.

It is preferable for the above-mentioned spacer particle dispersion that a specific gravity of the liquid portion of the dispersion when 80% by weight of the solvent is volatilized is lower than a specific gravity of the spacer particles. Accordingly, during the drying process of the droplets of the spacer particle dispersion after deposition, the spacer particles are settled in the spacer particle droplets and tend to be easily brought into direct contact with the substrate, so that the adhesive component becomes difficult to enter between the substrate and the spacer particles and the precision of the gap is not lowered.

In preparation of the spacer particle dispersion, it is supposed to be possible that an adhesive component with a low specific gravity and a solvent with high volatility as the solvent with a high specific gravity are used in combination.

The above-mentioned spacer particle dispersion is preferable to have a receding contact angle (Or) of 5 degree or wider. If the receding contact angle is 5 degree or wider, when a deposited droplet of the spacer particle dispersion on the substrate is dried, the droplet is shrunk toward the center of the droplet and one or more spacer particles contained in the droplet can gather in the center of the droplet. If it is narrower than 5 degree, the deposited droplet on the substrate is dried in the center of the point where the droplet is deposited (deposition center) and the droplet is shrunk there and the spacer particles scarcely gather toward the center.

In this description, the receding contact angle means a contact angle shown at the time when the droplet of the spacer particle dispersion on the substrate is becoming smaller than the initial diameter of the deposited droplet on the substrate (at the moment of starting shrinkage) during the process of drying the droplet of the spacer particle dispersion on the substrate from deposition of the droplet and practically means the value measured by observing the side face of the droplet of the spacer particle dispersion dropped on the substrate with a magnifying camera equipped with an image recording apparatus such as a digital video camera during the drying process of the droplet of the spacer particle dispersion (it is more preferable that the camera is equipped with an analyzer having an analyzing soft (e.g. FTA 32) capable of automatically obtaining the contact angle for every prescribed time from the measured image, and practically FTA 125 manufactured by First Ten Ångstroms, Inc, can be used.). The substrate temperature at the moment is a temperature at which the substrate is actually dried. The above-mentioned “at the moment of starting shrinkage” means the moment at which the size of the droplet starts shrinking significantly exceeding the range of variation as compared with the initial droplet diameter based on the observation of the side face. For example, the drying process of the droplet of the spacer particle dispersion dropped on the substrate is observed in the above-mentioned manner and in the case the correlation of alterations of the droplet diameter and the contact angle is graphed, as shown by arrows in FIGS. 6(a) and 6(b), if an inflection point appears, the contact angle at the inflection point is defined as the receding contact angle. FIG. 7 shows one example of the contact angle of the droplet of the spacer particle dispersion to the substrate.

The above-mentioned receding contact angle tends to become narrow as compared with so-called contact angle (an initial contact angle at the time when the droplet is put on the substrate and generally it is almost always called as contact angle). It is supposedly attributed to that on one hand, the initial contact angle is the contact angle of the droplet on the surface of the substrate which is not brought into contact with the solvent composing the spacer particle dispersion and on the other hand, the receding contact angle is the contact angle of the droplet on the surface of the substrate after the substrate is brought into contact with the solvent composing the spacer particle dispersion. That is, in the case the receding contact angle is considerably narrow as compared with the initial contact angle, it means that the alignment layer is damaged with the solvent and use of the angle is not desirable for the prevention of the alignment layer contamination. However, depending on a solvent composition composing the spacer particle dispersion, the receding contact angle may become higher than the initial contact angle during the drying process. For example, in the case a large quantity of a solvent with a low surface tension is contained, if the solvent with a low surface tension is removed during the drying process, in the process, that is, after the starting of the shrinkage of the droplet, the contact angle at the time of receding so-called droplet tail may possibly become higher than that at the initial moment.

A method for making the above-mentioned receding contact angle 5 degree or wider may be a method of adjusting the composition of a dispersion medium of the spacer particle dispersion or a method of adjusting the surface of the substrate.

To adjust the composition of the dispersion medium of the spacer particle dispersion, a medium with a receding contact angle of 5 degree or wider may be used alone or two or more of media may be used in form of a mixture. If two or more media are used in form of a mixture, it is made easy to adjust the dispersibility of the spacer particles and the workability and drying speed of the spacer particle dispersion and therefore it is preferable.

In the case two or more solvents are used in form of a mixture for the spacer particle dispersion, it is preferable to mix solvents in a manner that the receding contact angle (θr) of the solvent with the highest boiling point among the solvents to be mixed is adjusted to be 5 degree or wider. If the receding contact angle (θr) of the solvent with the highest boiling point is narrower than 5 degree, the droplet diameter in the later phase of the drying process becomes wide (the droplet wets and spreads on the substrate) and thus it becomes difficult for the spacer particles to gather in the center of the deposition.

A method for adjusting the surface of the substrate will be described later.

The upper limit of the receding contact angle of the spacer particle dispersion is preferably 70 degree. If the receding contact angle exceeds 70 degree, the effect of the substrate state proposed in the invention to gather the spacer particles may be sometimes lost. Further, in the case the specific gravity difference between the spacer particles and the liquid portion other than the spacer particles is narrow, since the spacer particles float in the droplets, when the spacer particles gather toward the drying center in the drying process of the droplet, the spacer particles are sometimes overlaid on other spacer particles and accordingly, the gap of the substrates of the liquid crystal display device to be produced cannot be kept precisely in some cases.

A method for making the above-mentioned receding contact angle 70 degree in the upper limit may be same as those methods for making the receding contact angle 5 degree or wider, that is a method of adjusting the composition of a dispersion medium of the spacer particle dispersion or a method of adjusting the surface of the substrate. That is, if the content of a solvent having a receding contact angle 70 degree or wider in a mixture of the dispersion media for the spacer particle dispersion is excess, the receding contact angle becomes too high during the drying process and thus it is undesirable, and to avoid the case, a proper amount of a solvent with a high receding contact angle may be added.

Further in the case the surface tension is low (for example, in the case of using a substrate coated with an alignment layer for perpendicular alignment mode), since not only the initial contact angle, which will be described later, but also the receding contact angle tends to become high, the addition amount of a solvent having a high receding contact angle to a common substrate is particularly limited.

The spacer particle dispersion is particularly preferable to have 25 degree in the lower limit and 65 degree in the upper limit, of the receding contact angle of a dispersion droplet to be ejected to the substrate.

A method for making the above-mentioned receding contact angle 25 degree in the lower limit and 65 degree in the upper limit may be a method of adjusting the composition of a dispersion medium of the spacer particle dispersion or a method of adjusting the surface of the substrate.

To adjust the composition of the dispersion medium of the spacer particle dispersion, a medium with a receding contact angle of 25 degree in the lower limit and 65 degree in the upper limit wider may be used alone or two or more of media may be used in form of a mixture. If two or more media are used in form of a mixture, it is made easy to adjust the dispersibility of the spacer particles and the workability and drying speed of the spacer particle dispersion and therefore it is preferable.

The upper limit of the receding contact angle of the spacer particle dispersion to the substrate is increased more as the specific gravity difference between the spacer particles and the liquid portion other than the spacer particles is widened more (as the specific gravity of the spacer particles is increased more), and if the specific gravity exceeds 0.1, more preferably 0.2, the above-mentioned upper limit of the receding contact angle is eliminated. It is supposedly attributed to that the spacer particles do not float in the droplet deposited on the substrate and are evenly settled on the substrate and accordingly overlaying of the spacer particles, which is a determining factor of the upper limit, scarcely occurs.

The above-mentioned spacer particle dispersion has 10 degree initial contact angle θ of the spacer particle dispersion to the substrate surface in the preferable lower limit and 110 degree in the preferable upper limit. If it is narrower than 10 degree, a space particle dispersion droplet ejected to the substrate wets the substrate a and spreads on the substrate and therefore, it sometimes become impossible to keep the arrangement intervals of the spacer particles narrow and if it exceeds 110 degree, the droplet moves around on the substrate even by a slight vibration and as a result, the arrangement precision is worsened and the adhesiveness of the spacer particles and the substrate may be lowered.

The above-mentioned spacer particle dispersion is preferable to have a viscosity of 0.5 mPa·s in the lower limit and 20 mPa·s in the upper limit at a head temperature of the ejecting moment measured by an E type viscometer or a B type viscometer. If it is lower than 0.5 mPa·s, it sometimes becomes difficult to control the ejecting amount at the moment of ejecting with an ink-jet apparatus and if it exceeds 20 mPa·s, it sometimes becomes impossible to eject the spacer particle dispersion by an ink-jet apparatus. The lower limit is more preferably 5 mPa·s and the upper limit is more preferably 10 mPa·s.

At the time of ejecting the spacer particle dispersion, the head of an ink-jet apparatus may be cooled by a Peltier element or a coolant or heated by a heater to adjust the liquid temperature in a range from −5° C. to 50° C. at the time of ejecting the spacer particle dispersion.

The spacer particle dispersion is preferable to have less than 5% solubility of the spacer particles in the alignment layer solvent. If it exceeds 5%, the alignment layer may be damaged or may contaminate the liquid crystal. The solubility in the alignment layer solvent can be measured by the following method.

That is, after the spacer particle dispersion in an amount equivalent to 100 mg of solid matter is vacuum dried at 90° C. for 5 hours and 150° C. for 5 hours, the dried spacer particle dispersion is baked at 220° C. for 1 hour (in the case the dispersion contains a photosetting resin as the adhesive component, ultraviolet rays of 2500 mJ intensity are radiated). The weight (Wa) of the cured product is measured and then the solid matter is separated by filtration, while putting 10 g of N-methyl 2-pyrolidone and oscillating, leave it for 5 hours, and vacuum dried at 150° C. for 5 hours and the weight (Wb) is measured. The solubility in the alignment layer solvent can be calculated according to the following equation.

Solubility in the alignment layer solvent=(Wa−Wb)/Wa

Next, an ink-jet apparatus to be used for ejecting the spacer particle dispersion to the substrate in the method of producing a liquid crystal display device will be described.

The above-mentioned ink-jet apparatus is not particularly limited and may be those employing conventionally known ejecting method such as a piezoelectric manner for ejecting a liquid by vibration of a piezoelectric element and a thermal ejecting manner for ejecting a liquid based on the liquid expansion by abrupt heating. Among them, the piezoelectric manner which scarcely causes thermal effect on the spacer particle dispersion to be ejected is preferable.

It is preferable that a liquid contact part of an ink chamber for storing the spacer particle dispersion of the above-mentioned ink-jet apparatus is composed of a hydrophilic material with a surface tension of 31 mN/m or higher. Although hydrophilic organic materials such as hydrophilic polyimides may be used as the material, inorganic materials such as ceramics, glass and metal materials such as a stainless steel with little corrosiveness are preferable in terms of the durability. In a common ink-jet apparatus, a resin is often employed in the head part for insulation to voltage application parts and in the case of materials with such a low surface tension, at the time of introducing the spacer particle dispersion into the head, since the wettability of the materials to the spacer particle dispersion is so inferior as to leave foams and if foams remain, the nozzle in which the foams remain becomes impossible to eject the spacer particle dispersion. Accordingly, the surface tension of at least the head part is preferably 31 mN/m or higher.

The nozzle diameter of the above-mentioned ink-jet apparatus is preferably 7 times as wide as the spacer particle diameter. If it is smaller than 7 times, the nozzle diameter is so small as compared with the particle diameter as to lower the ejecting precision and in an extreme case, the nozzle is clogged to make ejecting impossible in some cases. The reason for the decrease of the ejecting precision is supposed as follows. In the piezoelectric manner, an ink is sucked to an ink chamber adjacent to a piezoelectric element by vibration of the piezoelectric element or the ink from the ink chamber is passed through the tip end and thus ejected. As a droplet ejecting method, there are a drawing method involving drawing the meniscus (the interface of the ink and the gas) of the nozzle immediately before ejecting and then pushing the liquid and a pushing method involving directly pushing the liquid from the position at which the meniscus is disposed and with respect to a common ink-jet apparatus, the former drawing and pushing method is a mainstream manner and as a characteristic, small droplets can be ejected. In the spacer particle ejection of the invention, since the nozzle diameter is required to be large to a certain extent and it is required to eject small droplets, the drawing and pushing method is effective.

However, in the case of the drawing and pushing method, since the meniscus is drawn immediately before ejecting, if the nozzle aperture diameter is less than 7 times as small as the particle diameter, as shown in FIG. 2(a), if there exist spacer particles 21 in the periphery of the sucked meniscus 22, it is impossible to symmetrically draw the meniscus. Accordingly, at the time of ejecting the spacer particle dispersion 23 after the drawing, it is supposed that droplets cannot go straight but are curved and it results in decrease of the ejecting precision. In the case the nozzle aperture diameter is 7 times as large or larger than the particle diameter, as shown in FIG. 2(b), even if there exist spacer particles 21 in the periphery of the sucked meniscus 22, the drawing of the meniscus is not affected by the spacer particles 21. Accordingly, it is supposed that the meniscus 22 can be symmetrically drawn and at the time of pushing after the drawing, the droplets of the spacer particle dispersion 23 go straightly forward and it results in a high ejecting precision. However, to avoid curving of the droplets at the time of ejecting, if the nozzle diameter is unnecessarily widened, since the droplets to be ejected become large and the deposited droplet diameter thus becomes large, the arrangement precision of a charged ink and spacer particles 21 is undesirably lowered.

A droplet amount of the spacer particle dispersion to be ejected from the nozzle of the ink-jet apparatus is not particularly limited, however it is preferably 10 pL in the lower limit and 150 pL in the upper limit. A method for controlling the droplet amount may be a method for optimizing the aperture diameter of the nozzle or a method for optimizing the electric signals for controlling the ink-jet head. The latter method is particularly important in the case a piezoelectric type ink-jet apparatus is employed.

In the above-mentioned ink-jet apparatus, a plurality of nozzles as described above are installed in a prescribed arrangement manner in the ink-jet head. For example, 64 or 128 nozzles are arranged at equal intervals in the direction perpendicular to the head moving direction. In some cases, the nozzles are arranged in a plurality of rows, e.g. two rows.

The intervals of the nozzles in the above-mentioned ink-jet apparatus are restricted by the structure of the piezoelectric element and the nozzle diameter. Accordingly, in the case of ejecting the spacer particle dispersion to the substrate at intervals other than the intervals of the nozzle arrangement, it is difficult to make respective head ready for the respective ejecting intervals. Therefore, if the intervals are narrower than the intervals of the heads, ejecting is carried out generally while heads arranged perpendicularly to the scanning direction of the heads are slanted or turned in the plane parallel to the substrate while the heads are kept in parallel to the substrate. If the intervals are wider than the intervals of the heads, ejecting is carried out using some of nozzles but not all of the nozzles and also by slanting the heads.

To improve the productivity, it is also allowed to attach a plurality of heads with such a structure to the ink-jet apparatus, however if the number of the head to be attached is increased, the control becomes complicated and therefore it has to be careful.

FIGS. 3(a) and 3(b) show a schematic view of one example of a head of an ink-jet apparatus to be used in the invention. FIG. 3(a) schematically shows a partial perspective view of a structure of the example of the ink-jet head and FIG. 3(b) shows a partial perspective view of a cross-section of a nozzle hole part. As shown in FIGS. 3(a) and 3(b), the head 100 is provided with an ink chamber 101 previously filled with an ink by suction and the like and an ink chamber 102 to which the ink is fed from the ink chamber 101. The head 100 has nozzle holes 104 extended from the ink chamber 102 to an ejection face 103. The ejection face 103 is previously subjected to hydrophobic treatment to prevent the pollution with the ink. Temperature control means 105 for adjusting the viscosity of the ink is installed in the head 100. The head 100 is equipped with a piezoelectric element 106 having a function of sending the ink from the ink chamber 101 to the ink chamber 102 and a function of ejecting the ink through the nozzle holes 104.

Since the above-mentioned temperature control means 105 is installed in the head 100, in the case the viscosity is too high, the ink is heated by the heater to lower the viscosity of the ink, and in the case the viscosity is too low, the ink is cooled by the Peltier element to increase the viscosity of the ink.

A substrate to be subject to the method of producing a liquid crystal display device of the invention is not particularly limited and glass and resins commonly used as a panel substrate for a liquid crystal display device may be employed. Further, one substrate between a pair of substrates may be a substrate provided with a color filter in a pixel region. In this case, the pixel region is defined by a black matrix of a resin in which a metal such as chromium or carbon black is dispersed to scarcely allow light transmission effectively. The black matrix forms the non-pixel region.

The above-mentioned substrate is preferable to be previously subjected to hydrophobic treatment, so that the contact angle of the spacer particle dispersion to the substrate can be 20 degree or higher.

The above-mentioned hydrophobic treatment may be carried out by a dry method such as a normal pressure plasma method and a CVD method; and a wet method of applying a silicone type, fluoro type, or long chain alkyl type water-repelling agent to the surface of the substrate, and especially the normal plasma method is preferable among these methods.

In the case the substrate is previously subjected to hydrophobic treatment, it is preferable to carry out de-hydrophobicity treatment after the spacer particle arrangement. If the hydrophobic treatment is carried out, it becomes difficult to apply an alignment layer formation solution and no alignment layer can be formed in some cases. The de-hydrophobicity treatment may be carried out by a dry method such as a normal pressure plasma method and corona treatment; a wet method such as a surface oxidization method, and a method for removing the water-repelling coating by a solvent.

The above-mentioned substrate is previously made to have a low energy surface with a surface energy of 45 mN/m or lower so as to adjust the receding contact angle (θr) of the spacer particle dispersion to the surface to be 5 degree or wider in a position where a ejected droplet of the spacer particle dispersion is deposited.

A method for making the surface of the substrate be a low energy surface may be a method of applying a resin having a low energy surface such as a fluoro coating or a silicone coating, however generally, in order to restrict the alignment of the liquid crystal molecules on the surface of the substrate, a method for forming so-called alignment layer, a resin thin coating (generally 0.1 μm or thinner), is carried out. Generally, a polyimide resin coating is employed for the alignment layer. The polyimide resin coating can be formed by applying a solvent-soluble polyamic acid and then carrying out heat polymerization of the acid or by applying soluble polyimide and then drying the polyimide. As the polyimide resin, those having long side chains and main chains are preferable to obtain the low energy surface. The above-mentioned alignment layer is subjected to surface rubbing treatment after the application to control the alignment of the liquid crystal. A medium for the above-mentioned spacer particle dispersion has to be selected from those which do not contaminate the alignment layer by penetration or dissolution in the alignment layer.

In the method of producing a liquid crystal display device of the invention, the position of the substrate where the spacer particle dispersion is ejected and deposited is a position corresponding to the non-pixel region.

The position corresponding to the non-pixel region is a non-pixel region (in the case of a color filter substrate, the above-mentioned black matrix) or a region (in the case of a TFT array substrate, the wiring part and the like) corresponding to the non-pixel region of the other substrate (in the case of a TFT liquid crystal panel, the TFT array substrate) when the substrate is overlaid on the other substrate having the non-pixel region.

The above-mentioned position corresponding to the non-pixel resin may include a part having a step from the surrounding. Herein, the step means non-intentional concavity and convexity (the height difference from the surrounding) formed by wiring on the substrate and concavity and convexity intentionally formed to gather the spacer particles and any structure is allowed as the structure under the concavity and convexity. Accordingly, the step here means the step between a flat part (base level) and either a concave part or a convex part of the irregular surface shape.

The method of producing a liquid crystal display device of the invention will be described more in detail.

In the method of producing a liquid crystal display device of the invention, at first, ejecting droplets of the above-mentioned spacer particle dispersion with an ink-jet apparatus and depositing the droplet at prescribed positions on the above-mentioned substrate.

The above-mentioned spacer particle dispersion is preferable to be ejected at a prescribed gap to the substrate represented by the following formula (1). The gap means the minimum gap between droplets in the case the next droplets are ejected before the deposited droplets of the spacer particle dispersion are not dried yet.

$$\begin{matrix}[ Eq . 1 ] & \\ 35 * {( \frac{D}{( 2 - 3 cos θ + {cos}^{3} θ )} )}^{1 / 3} ( μ m ) & ( I )\end{matrix}$$

θ: contact angle between the spacer particle dispersion and the substrate surface

In the above formula (1), D represents a particle diameter (μm) of the spacer particles; and θ represents initial contact angle between the spacer particle dispersion and the substrate surface.

If it is tried to eject the droplets at a narrower gap than the gap represented by the above-mentioned formula (1), since the droplet diameter is large as it is and the deposited droplet diameter also becomes large and droplets coalesce and accordingly aggregation of the spacer particles toward one point cannot be caused during the drying process. As a result, the arrangement precision of the spacer particles is worsened after drying. On the other hand, if the nozzle diameter is made so narrow as to decrease the ejected droplet amount, since the spacer particle diameter becomes large relatively to the nozzle diameter, as described above, it is made impossible to eject the spacer particles stably, straightly and constantly in one direction out from the ink-jet head nozzles and the deposition position precision is thus lowered due to the curve. Further, the nozzles may be clogged with the spacer particles.

The arrangement number (dispersion density) of the spacer particles to be ejected as represented by the above formula (1) and arranged on the substrate is preferably 25 particle/mm² in the lower limit and 350 particle/mm² in the upper limit. As long as the particle density is controlled in the above-mentioned range, the spacer particles may be arranged in an optional pattern in any portion of the non-pixel region such as a black matrix and a region corresponding to the non-pixel region such as wiring. However, in order to prevent invasion of the spacer particles in the display part (the pixel region), it is preferable to arrange the spacer particles on the portion of one substrate corresponding to the lattice points of the light-blocking region in a lattice-like shape in the case of a color filter comprising the light-blocking region (non-pixel region) in the lattice-like shape. Additionally, the standard deviation of the sprayed density of the spacer particles per 1 mm² in a specified range on the substrate is preferably within 40% of the average value of the sprayed density in the specified range. If it exceeds 40%, the cell gap becomes uneven and it may sometimes cause an adverse effect on the display state.

The number of the spacer particles to be arranged on the substrate is preferably 50 in the upper limit per one arrangement position on the substrate where the spacer particle dispersion is ejected and deposited. The lower limit is not particularly limited and it may be 0 as long as the sprayed density per 1 mm² is within the above-mentioned range, that is, it is allowed there is a position where no spacer particle is arranged.

The average number of ejected spacer particles in a specified region of the substrate is preferably 0.2 in the lower limit and 15 in the upper limit.

A method for adjusting the sprayed density as described may be a method for changing the concentration of the spacer particles in the spacer particle dispersion; a method for changing the ejecting intervals of the spacer particle dispersion; and a method for changing the droplet amount to be ejected one time.

In the case the sprayed density is changed by the method for changing the concentration of the spacer particles in the spacer particle dispersion, the type of the spacer particles contained in the spacer particle dispersion may be changed. Accordingly, for every specified range of the substrate, the physical properties such as particle diameter, hardness, and restoration ratio of the spacer particles may be changed.

The above-mentioned method for changing the droplet amount to be ejected one time may be a method for adjusting the waveform of voltage to be applied to the ink-jet head and a method for ejecting the droplets a plurality of times to one position.

To eject the spacer particle dispersion and deposit the droplets of the dispersion on the substrate, scanning of the ink-jet head is carried out only one time or separately a plurality of times. Particularly in the case that the intervals for the arrangement of the spacer particles are narrower than the interval represented by the above-mentioned formula (1), ejecting may be carried out at intervals integer times as long as the defined interval and drying may be carried out successively to eject the spacer particles again after displacing the corresponding defined intervals. With respect to the movement (scanning) direction, ejecting may be carried out while the direction is changed every time (reciprocating ejection) or ejecting may be carried out only in scanning in one direction (unidirectional ejection).

Further, in such an arrangement method, as described in Japanese Kokai Publication 2004-037855, the head may be slanted at an angle to the perpendicular line to the substrate face to change the ejecting direction of the droplets (generally parallel to the perpendicular line to the substrate face) and the relative speed of the head and the substrate may be controlled. In such a manner, the droplet diameter to be deposited can be made small to make arrangement of the spacer particles in a region defining the pixel region or the corresponding region much easier.

In the method of producing a liquid crystal display device of the invention, a deposited droplet of the spacer particle dispersion is then dried, and thereby arranging the spacer particles on the substrate.

A method for drying the spacer particle dispersion is not particularly limited and may be a method for heating the substrate or a method for blowing hot air.

To gather the spacer particles near the center of the deposited droplet during the drying process, it is preferable that the boiling point of the medium, drying temperature, drying duration, surface tension of the medium, contact angle of the medium to the alignment layer, concentration of the spacer particle and the like are set in appropriate conditions.

To gather the spacer particles in the deposited droplet during the drying process, the drying should be carried out for a certain duration so as to keep the liquid during the time the spacer particles move on the substrate. Therefore, conditions of intensely drying up the solvent are not preferable. Further, if the medium is brought into contact with the alignment layer for a long duration, the medium sometimes contaminates the alignment layer and deteriorates the display image quality of the liquid crystal display device and therefore it is not preferable.

When a medium considerably volatile at a room temperature is used or a medium is used in conditions of intensely volatilizing the medium, the spacer particle dispersion tends to be dried in the periphery of the nozzle of the ink-jet apparatus and thus deteriorates the ink-jet ejecting property and therefore, it is also not preferable. Further, agglomerated particles may be produced by drying during the production of the dispersion or in a tank and it is also not preferable.

Even if the substrate temperature is relatively low, if the drying duration is considerably prolonged, the productivity of the liquid crystal display device is lowered and therefore, it is not preferable.

The substrate surface temperature at the time of deposition of the spacer particle dispersion is preferably a temperature lower than the boiling point of the solvent having the lowest boiling point and contained in the dispersion by 20° C. or more. If the temperature is higher than the temperature lower than the boiling point of the solvent having the lowest boiling point by 20° C., the solvent having the lowest boiling point is abruptly volatilized and not only the spacer particles can move but also the droplet as itself move on the substrate due to the abrupt boiling of the solvent in an extreme case to result in significant decrease of the arrangement precision of the spacer particles and therefore it is not preferable.

Further, when the medium is dried by gradually increasing the substrate temperature after the deposition of the spacer particle dispersion on the substrate, the substrate surface temperature is preferably 90° C. or lower and more preferably 70° C. or lower until the completion of the drying. If the substrate surface temperature exceeds 90° C. until the completion of the drying, the alignment layer is contaminated and display image quality of the liquid crystal display device is deteriorated and therefore, it is not preferable.

The substrate on which the spacer particles are arranged can be obtained in the above-mentioned process.

With respect to the substrate on which the spacer particles are arranged, it is preferable that the above-mentioned adhesive component is stuck to at least some of the spacer particles and fixes the particles on the substrate.

The fixation state of the spacer particles is not particularly limited and may include the state that the adhesive component exists between the lower parts of the spacer particles and the substrate; the state that the spacer particles are half-embedded in the adhesive component on the substrate and fixed on the substrate; and the state that the spacer particles are completely embedded in the adhesive component on the substrate and fixed on the substrate. FIG. 1 is a schematic view showing the fixation state of the spacer particles.

From this viewpoint, the adhesive component may be stuck to the upper parts of the spacer particles.

With respect to the substrate on which the spacer particles are arranged, in the case two or more spacer particles are arranged in a single arrangement position on the substrate, it is preferable that the distance between the centers of two spacer particles existing nearest to each other is at most two times as wide as the spacer particle diameter. That is, in terms of the arrangement precision, it is preferable that the spacer particles are not longitudinally overlaid one another and closely adhere to the neighboring spacer particles.

With respect to the substrate on which the spacer particles are arranged, the gap between the spacer particles and the substrate is preferably 0.2 μm or narrower. If it exceeds 0.2 μm, the cell cap cannot be kept precisely in some cases. That is, if the adhesive component excessively enters between the spacer particles and the substrate, particularly in the case that elastic modulus of the adhesive component is high, the adhesive component may sometimes affect the gap precision.

In the substrate on which the spacer particles are arranged, the variation (standard deviation) of the distance from the uppermost parts of the spacer particles (the points most apart from the substrate) to the substrate is preferably 10% or less. If it exceeds 10%, the cell gap cannot be precisely formed in some cases.

In the substrate on which the spacer particles are arranged, the variation (standard deviation) of the distance from the uppermost parts of the adhesives attached on top of the spacer particles (the points most apart from the substrate) to the substrate is preferably 10% or less. If it exceeds 10%, the cell gap cannot be precisely formed in some cases.

With respect to the substrate on which the spacer particles are arranged, the cohesive power of the spacer particles is preferably 0.2 μN/particle in the lower limit. The lower limit is more preferably 1 μN/particle and even more preferably 5 μN/particle.

The power at the moment when the spacer particles are moved is measured by scanning a contactor on the substrate in the contact state while applying a constant and very small load to the substrate by a nano-scratch tester (manufactured by Nanotech Cooperation) and bringing the contactor into contact with the agglomerated spacer particles fixed by the adhesive and the cohesive power of the spacer particles in this description can be calculated by dividing the measured power by the number of the spacer particles.

With respect to the substrate on which the spacer particles are arranged, the stress at the moment of 10% deformation (10% deformation stress) of the spacer particles from the uppermost part (the points of the spacer particles most apart from the substrate) in the substrate direction is preferably 0.2 mN in the lower limit and 10 mN in the upper limit.

The above-mentioned 10% deformation stress can be measured by the following method. That is, at 10 arrangement positions, the stress at the moment of 10% deformation is measured by a 100 μm contactor of a micro hardness meter (manufactured by Shimadzu Corp.). The stress is measured for every arrangement position and the value is calculated by dividing the stress by the number of the spacer particles existing at the arrangement position and an average values is defined as the 10% deformation stress.

With respect to the substrate on which the spacer particles are arranged, the restoration ratio of the spacer particles is preferable 40% or higher.

The above-mentioned restoration ratio can be measured by the following method. That is, at 10 arrangement positions, a load calculated by multiplying 9.8 (mN) by the number of the spacer particles existing at every arrangement position is applied for 1 second and the alteration of the distance between the substrate and the uppermost part of the spacer particles (the points of the spacer particles most apart from the substrate) is measured before and after the load application. The average of the values calculated by dividing the distance after the load application by the distance before the load application for 10 arrangement positions is defined as the restoration ratio.

With respect to the substrate on which the spacer particles are arranged, it is preferable that 80% or more of the spacer particles exist in the region of the substrate corresponding to the light-blocking region of the liquid crystal display device.

With respect to the substrate on which the spacer particles are arranged, the alteration ratio of the existence of the spacer particles is preferably within ±20% before and after a vibration test carried out according to the method of JIS C 0040 (Shock vibration (acceleration 50G (9 m·s)) and 5 minute vibration with sinusoidal wave (0.1 KHz 30G, 1 KHz 30G).

As described above, after the spacer particles are arranged on the substrate to obtain the substrate on which the spacer particles are arranged, another substrate is overlaid face to face on the substrate on which the spacer particles are arranged while sandwiching the spacer particles between the substrates by a common method and successively both substrates are thermally press bonded and the gap formed between the substrates is filled with the liquid crystal to produce the liquid crystal display device (vacuum injection method). Further, a peripheral seal agent is applied to one substrate and the liquid crystal is dropwise dripped on the region surrounded with the seal agent and then the other substrate is stuck and then the seal agent is cured to produce the liquid crystal display device (one drop fill process).

The method of producing a liquid crystal display device also constitutes the invention and the liquid crystal display device produced using the spacer particle dispersion also constitutes the invention.

In the method of producing a liquid crystal display device of the invention, before and after the process of producing the liquid crystal display device by obtaining an substrate, on which the spacer particles are arranged by ejecting the spacer particle dispersion to the substrate and drying the dispersion, and overlaying an opposed substrate on the obtained substrate while sandwiching the spacer particles arranged on the obtained substrate and a liquid crystal; the alteration ratio of the volume resistivity of the liquid crystal is preferably 1% or higher and the alteration of the NI point is in ±1° C.

The alteration ratio of the volume resistivity of the liquid crystal is measured by the following method. That is, the spacer particle dispersion is ejected to the glass substrate with a size of 100×100 mm to arrange the spacer particles on the substrate and baked at 220° C. for 1 hour (in the case the dispersion contains a photosetting resin as the adhesive component, ultraviolet ray radiation of 2500 mJ is performed) and an alignment layer (SE-7492, manufactured by Nissan Chemical Industries, Ltd.) is formed and fired at 220° C. for 2 hours. After that, the substrate is washed with water and dried at 105° C. for 30 minutes and successively 0.5 g of a liquid crystal (Chisso Lixon JC5007LA) is bought into contact. Using a resistivity measurement apparatus manufactured by Toyo Cooperation, the volume resistivity is measured in condition of 5V and 25° C. and the alteration ratio of the volume resistivity is calculated according to the following equation. As the alteration ratio of the volume resistivity is closer to 100%, it can be said that the contamination is less.

Alteration ratio of the volume resistivity=(volume resistivity of the liquid crystal after the test)/(volume resistivity of the liquid crystal before the test)×100

The NI point of the liquid crystal is measured as follows; the nematic-isotropic phase transition temperature (NI point) is measured at 10° C./min scanning in a temperature range from 0 to 110° C. by using a DSC apparatus and the alteration of the nematic-isotropic phase transition temperature is calculated according to the following equation.

Alteration of NI point=(NI point before the test)−(NI point after the test)

If the alteration ratio of the volume resistivity of the liquid crystal is 1% or higher, the display quality such as the contrast and color tone of the liquid crystal display device is excellent. If the alteration ratio of the volume resistivity of the liquid crystal is less than 1%, the liquid crystal is contaminated with foreign materials having conductivity and existing in the spacer particle dispersion and the display quality of the liquid crystal display device is lowered and afterimages and unevenness of display occur. The alteration ratio of the volume resistivity of the liquid crystal is preferably 10% or higher. If the alteration ratio of the volume resistivity of the liquid crystal is 10% or higher, the display quality of the liquid crystal display device is further excellent.

If the nematic-isotropic phase transition temperature is within ±1° C., the display quality of the liquid crystal display device is excellent. If the nematic-isotropic phase transition temperature is out of ±1° C., the liquid crystal is contaminated with organic materials existing in the spacer particle dispersion and being compatible with the liquid crystal, the display quality of the liquid crystal display device is lowered and afterimages and unevenness of display occur.

### EFFECTS OF THE INVENTION

Accordingly, the invention provides a method of producing a liquid crystal display device, which comprises a step of ejecting a droplet of a spacer particle dispersion with an ink-jet apparatus, depositing the droplet at a prescribed position on a substrate, then drying the droplet, and thereby arranging the spacer particle on the substrate, and by which the spacer particles are arranged precisely at a prescribed position and a spacer particle dispersion preferably usable for the method of producing a liquid crystal display device.

### BEST MODE FOR CARRYING OUT THE INVENTION

Hereinafter, the invention will be described further in detail along with Examples, however it is not intended that the invention be limited to these Examples.

### EXAMPLE 1

### Preparation of Spacer Particles

(1) In a separable flask, divinylbenzene 15 parts by weight, isooctyl acrylate 5 parts by weight, and benzoyl peroxide as a polymerization initiator 1.3 parts by weight were mixed evenly. Next, an aqueous 3% polyvinyl alcohol solution (trade name: Kuraray Poval GL-03, manufactured by Kuraray Co., Ltd.) 20 parts by weight and sodium dodecylsulfate 0.5 parts by weight were added and well stirred. Thereafter, ion exchanged water 140 parts by weight was added. While the obtained solution was stirred, reaction was carried out at 80° C. for 15 hours in nitrogen current. After being washed with hot water and acetone, the obtained particles were classified to obtain spacer particles with an average particle diameter of 4.0 μm and CV value of 3.0% and having no surface treatment layer.

The obtained spacer particles having no surface treatment layer 5 parts by weight were added to dimethyl sulfoxide (DMSO) 20 parts by weight, hydroxymethyl methacrylate 2 parts by weight, and N-ethylacrylamide 18 parts by weight and evenly dispersed by a sonicator. Thereafter, nitrogen gas was introduced into the reaction system and the reaction system was continuously stirred at 30° C. for 2 hours. Next, 10 parts by weight of a 0.1 mol/L ceric ammonium nitrate solution produced using an aqueous 1N nitric acid solution was added and reaction was continued for 5 hours. On completion of the reaction, particles and the reaction solution were separated by filtration with a membrane filter of 2 μm. The particles were sufficiently washed with ethanol and acetone and vacuum dried by a vacuum drier to obtain spacer particles SA with three kinds of average particle diameters and having a surface treatment layer.

(2) The obtained spacer particles having no surface treatment layer 5 parts by weight were added to dimethyl sulfoxide (DMSO) 20 parts by weight, hydroxymethyl methacrylate 2 parts by weight, methacrylic acid 16 parts by weight, and lauryl acrylate 2 parts by weight and evenly dispersed by a sonicator. Thereafter, nitrogen gas was introduced into the reaction system and the reaction system was continuously stirred at 30° C. for 2 hours. Next, 10 parts by weight of a 0.1 mol/L ceric ammonium nitrate solution produced using an aqueous 1N nitric acid solution was added and reaction was continued for 5 hours. On completion of the reaction, particles and the reaction solution were separated by filtration with a membrane filter of 2 μm. The particles were sufficiently washed with ethanol and acetone and vacuum dried by a vacuum drier to obtain spacer particles SB having a surface treatment layer.

(3) The obtained spacer particles having no surface treatment layer 5 parts by weight were added to dimethyl sulfoxide (DMSO) 20 parts by weight, hydroxymethyl methacrylate 2 parts by weight, and polyethylene glycol methacrylate (molecular weight 800) 18 parts by weight and evenly dispersed by a sonicator. Thereafter, nitrogen gas was introduced into the reaction system and the reaction system was continuously stirred at 30° C. for 2 hours. Next, 10 parts by weight of a 0.1 mol/L ceric ammonium nitrate solution produced using an aqueous 1N nitric acid solution was added and reaction was continued for 5 hours. On completion of the reaction, particles and the reaction solution were separated by filtration with a membrane filter of 2 μm. The particles were sufficiently washed with ethanol and acetone and vacuum dried by a vacuum drier to obtain spacer particles SC having a surface treatment layer.

(4) The obtained spacer particles having no surface treatment layer 10 parts by weight were added to methyl ethyl ketone 20 parts by weight and a toluene solution containing 30% of methacryloyl isocyanate 3 parts by weight and reaction was carried out at 100 to 150° C. for 1 to 2 hours to introduce vinyl group on the surfaces of the spacer particles. Thereafter, the spacer particles surface modified with vinyl group were obtained by centrifugation. The obtained spacer particles having vinyl group 10 parts by weight was added to 2,2′-azobisisobutyronitrile as a polymerization initiator 1 part by weight and methyl cellosolve 100 parts by weight. Next, the mixture was heated to 60° C., which is a ring-opening temperature of the initiator, and reaction was carried out for 2 hours in nitrogen current to generate radical in the vinyl group on the particle surfaces. After that, 5 parts by weight of hydroxymethyl methacrylate which is a polymerizable vinyl monomer having OH group and whose homopolymer is soluble in methyl cellosolve and 45 parts by weight of polyethylene glycol methacrylate (molecular weight 800) were dropwise added and reaction was carried out for 1 hour to obtain spacer particles having an adhesion layer containing graft polymer chains on the surface. On completion of the reaction, the spacer particles and the reaction solution were separated by filtration with a membrane filter of 2 μm. The spacer particles were sufficiently washed with ethanol and acetone and vacuum dried by a vacuum drier to obtain spacer particles SD having a surface treatment layer surface-modified with the graft polymer. The physical properties of the obtained spacer particles SA, SB, SC and SD are respectively shown in the following Table 1.

TABLE 1

| | | | | | | | | | | | | | | | | δ |
|---|---|---|---|---|---|---|---|---|---|---|---|---|---|---|---|---|
| | | | | | | | | | | | | | | | | calculation |
| | | | | | | | | | | | | | | | | value |
| | surface treatment monomer blend | | | | | | | surface polymer composition (TOF-SIMS analysis results) | | | | | | | | (cal/ |
| | HEMA | IBMA | LA | MPEG | NEtAAm | MAA | AA | HEMA | IBMA | LA | MPEG | NEtAAm | MAA | AA | PVA | cm³)^{1/2} |
| SA | 2 | | | | 18 | | | 9.3% | 0.0% | 0.0% | 0.0% | 90.6% | 0.0% | 0.0% | 0.0% | 13.11 |
| SB | 2 | | 2 | | | 16 | | 10.1% | 0.0% | 6.3% | 0.0% | 0.0% | 83.5% | 0.0% | 0.0% | 11.03 |
| SC | 2 | | | 18 | | | | 78.5% | 0.0% | 0.0% | 21.3% | 0.0% | 0.0% | 0.0% | 0.2% | 10.46 |
| SD | 5 | | | 45 | | | | 80.2% | 0.0% | 0.0% | 19.7% | 0.0% | 0.0% | 0.0% | 0.1% | 10.44 |

| | |
|---|---|
| (part by | (mol %) |
| weight) | |

δ (parameter of monomer unit for SP value calculation)

| | HEMA | IBMA | LA | MPEG | NEtAAm | MAA | AA | PVA | |
|---|---|---|---|---|---|---|---|---|---|
| Mw | 131.1 | 143.2 | 240.4 | 1026.2 | 99.1 | 86.1 | 72.1 | 83535 | molecular weight |
| Σ [symbol] F | 1241.6 | 1266.2 | 2147.6 | 8964.6 | 1187.6 | 629.0 | 533.6 | 757105 | integrated value of molar attraction constant |
| Σ [symbol] v | 122.2 | 154.2 | 253.7 | 904.1 | 85.2 | 53.5 | 42.8 | 64250 | integrated value of molar volume |

abbreviation
HEMA hydroxy ethylmethacrylate
IBMA isobutyl methacrylate
LA lauryl acrylate
MPEG methoxy polyethylene glycol methacrylate
NEtAAm N-ethylacrylamide
MAA methacrylic acid
AA acrylic acid
PVA polyvinyl alcohol*
*residue which exists in the spacer surfaces before surface treatment remains.

### (Preparation of Adhesive Component (Solution))

A monomer mixture 117.7 parts containing 100 parts by weight of n-butoxymethylacrylamide, 11.8 parts by weight of hydroxyethyl methacrylate, and 5.9 parts by weight of methacrylic acid was dissolved in diethyl phthalate 352.9 parts and loaded to a separable flask and after replacement with nitrogen, while an ethanol solution containing 10% by weight of an oil-soluble azo type polymerization initiator (trade name: V-65, manufactured by Wako Pure Chemical Industries, Ltd.) 11.8 parts was dropwise added for 1 hour, polymerization reaction was carried out and then ethanol was removed by reducing the pressure at 40° C. to obtain an adhesive component solution A.

After polymerization reaction was carried out using MEK in place of diethyl phthalate as a solvent, diacetin 200 g and diethyl malonate 100 g were added and successively, MEK and ethanol were removed by reducing the pressure to obtain an adhesive component solution B. In the same manner, an adhesive component solution C was obtained from glycerin 100 g and diethyl malonate 100 g and an adhesive component solution D was obtained from diethylene glycol 200 g and diethyl malonate 50 g.

The physical properties of the raw materials composing the solvents for the obtained respective adhesive components are shown in the following Table 2.

TABLE 2
d: specific gravity M: molecular weight V: molar volume δ: SP value (solubility parameter)

| | | | | | | | | | δ calculation | | | | | |
|---|---|---|---|---|---|---|---|---|---|---|---|---|---|---|
| | bp | γ | η₂₀ | d₂₀ | M | V | | | value | blend for Examples | | | | |
| | ° C. | mN/m | mPa · s | g/cm³ | g/mol | cm³/mol | ΣΔF | ΣΔv | (cal/cm³)^{1/2} | A | B | C | D | E |
| water | 100 | 72.6 | 1.0 | 0.998 | 18.02 | 18.05 | 423 | 20.0 | 21.150 | 0 | 0 | 0 | 0 | 100 |
| diethylene glycol | 245 | 48.5 | 35.7 | 1.116 | 106.12 | 95.06 | 1188 | 95.1 | 12.5 | 0 | 0 | 0 | 200 | 0 |
| glycerin | 290 | 63.3 | 1412 | 1.263 | 92.09 | 72.90 | 1103 | 68.0 | 16.2 | 0 | 0 | 100 | 0 | 100 |
| diethyl phthalate | 282 | 32.0 | 17.2 | 1.194 | 222.24 | 186.13 | 2035 | 197.8 | 10.3 | 100 | 0 | 0 | 0 | 0 |
| diacetin | 259 | 36.0 | 35.7 | 1.179 | 352.34 | 298.84 | 1804 | 144.8 | 12.5 | 0 | 200 | 0 | 0 | 0 |
| diethyl malonate | 199 | 31.7 | 2.2 | 1.055 | 160.17 | 151.82 | 1512 | 152.3 | 9.9 | 0 | 100 | 100 | 50 | 0 |

| | | | | | |
|---|---|---|---|---|---|
| SP value of solvent mixture | 10.3 | 11.9 | 11.7 | 11.7 | 17.4 |
| (cal/cm³)^{1/2} | | | | | |

Reference to “Adhesion”, vol. 40, no. 8, p. 342-p.350 and p. 391-p. 399
δ: SP value calculation, from Table 3-3 (Okitsu) polymer, solvent: based on formulas (3·4) and (3·5) solvent mixture: based on formula (2·8)

### (Preparation of Spacer Particle Dispersions)

The four kinds of the spacer particles having the surface treatment layer in necessary amounts to adjust a prescribed particle concentration (0.5% by weight) were added to an adhesive component solution A which was diluted to have a prescribed adhesive component concentration (0.1% by weight) and dispersed by sufficiently stirring with a sonicator. Thereafter, the obtained solutions were filtered by a stainless mesh with 10 μm aperture to remove agglomerates and obtain four kinds of spacer particle dispersions.

The spacer particle dispersions using the adhesive component solution A had a solubility parameter value of 10.3 for the liquid phase part other than the spacer, which was calculated by a method described later.

In the same manner, 12 kinds in total of spacer particle dispersions were produced using adhesive component solutions B, C, and D. The solubility parameter value for the liquid phase part of the adhesive component solution B other than the spacer of was 11.9. The solubility parameter value for the liquid phase part of the adhesive component solution C other than the spacer of was 11.7, and the solubility parameter value for the liquid phase part of the adhesive component solution D other than the spacer of was 11.7.

### (Preparation of Substrates)

### (1) Preparation of Color Filter Model Substrate

A black matrix of metal chromium (width 25 μm, longitudinal intervals 150 μm, transverse intervals 75 μm, and thickness 0.2 μm) was formed on a glass substrate by a common method. Pixels of a color filter 44 (thickness 1.5 μm) comprising three colors of red, green, and blue were formed on and in the black matrix 43 in a manner that the surface became flat. An overcoat layer with an approximately constant thickness and an ITO transparent electrode were formed thereon. Further, water-repelling treatment was carried out using CF₄/N₂ gas mixture by “Normal pressure plasma surface treatment apparatus” manufactured by Sekisui Chemical Co., Ltd.) to prepare a color filter model substrate. The surface tension of the color filter model substrate was 27.4 mN/m.

### (2) Preparation of TFT Array Model Opposed Substrate

A black matrix of metal chromium (width 25 μm, longitudinal intervals 150 μm, transverse intervals 75 μm, and thickness 0.2 μm) was formed on a glass substrate by a common method. Pixels of a color filter (thickness 1.5 μm) comprising three colors of red, green, and blue were formed on and in the black matrix in a manner that the surface became flat. Next, a step (width 8 μm and height difference 5 nm) of copper was formed at position corresponding to the black matrix on a glass substrate by a conventionally known method. An ITO transparent electrode with an approximately constant thickness was formed thereon.

Further, a polyimide resin solution (Sunever SE1211, manufactured by Nissan Chemical Industries, Ltd.) was evenly applied to the substrate by a spin coating method. After the application, the solution was dried at 0° C. and fired at 210° C. for 1 hour for curing to form an alignment layer with an approximately constant thickness and accordingly prepare a TFT array model substrate.

The surface tension of the formed alignment layer was 30.2 mN/m.

### (Preparation of Ink-Jet Apparatus)

An ink-jet apparatus equipped with a piezoelectric type head with an aperture diameter of 50 μm was made available. The liquid contact part of the ink chamber of the head was made of a glass ceramic material. The nozzle faces were subjected to water-repelling treatment with a fluoro material.

### (Arrangement of Spacer Particles)

Using each of the obtained spacer particle dispersions, the spacer particles were arranged on the color filter model substrate by an ink-jet apparatus. At the time of arrangement of the spacer particles, 0.5 mL of the spacer particle dispersion ejected initially out of the nozzles of the ink-jet apparatus was discarded and then the arrangement was started.

At first, the substrate was put on a stage heated to 45° C. by a heater. Using the above-mentioned ink-jet apparatus, droplets of the spacer particle dispersion were ejected and arranged at 110 μm longitudinal×150 μm transverse pitches on every other longitudinal lines at 110 μm intervals and dried. The gap between the nozzle tip ends and the substrate was 0.5 mm at the time of ejecting and a double pulse method was employed for ejecting.

After ejecting, the droplets were dried at 90° C. to evaporate the solvent and thereafter baked at 220° C. for 1 hour to cure the adhesive component.

FIG. 4 shows an electron microscopic photograph of the arrangement state of the spacer particles using the spacer particle SA dispersion (using the adhesive component solution A) and FIG. 5 shows an electron microscopic photograph of the arrangement state of the spacer particles using the spacer particle SB dispersion (using the adhesive component solution A). The concentration of the adhesive component was 0.3% by weight in both cases.

After that, the color filter model substrate on which the spacer particles were arranged was subjected to water-repelling treatment by corona treatment (the initial contact angle of the following polyimide resin solution to the substrate immediately after the treatment was 0 degree), the polyimide resin solution (Sunever SE1211, manufactured by Nissan Chemical Industries, Ltd.) was evenly applied to the substrate by a spin coating method. After the application, the solution was dried at 80° C. and fired at 210° C. for 1 hour for curing to form an alignment layer with an approximately constant thickness.

### (Completion of Liquid Crystal Display Device)

The color filter model substrate on which spacer particles were arranged and the TFT array model substrate, which was a opposed substrate, were stuck to each other using a peripheral seal agent. After the sticking, the seal agent was heated at 150° C. for 1 hour for curing to produce an empty cell having a cell gap equal to the particle diameter of the spacer particles and successively the cell was filled with a liquid crystal by a vacuum method and an injection port was sealed with a sealing agent to produce a liquid crystal display device.

### (Evaluation)

### (1) Evaluation of Spacer Particle Dispersion

For each spacer particle dispersion, the surface tension, receding contact angle, viscosity at 25° C., specific gravity, specific gravity difference between the spacer particles and the liquid portion other than the spacer particles, solubility parameter value difference between the surface of the spacer particles and the liquid portion other than the spacer particles (SP value or δ; unit is [(cal/cm³)^{1/2}]), and solubility in solvent of an alignment layer were evaluated. The receding contact angle, solubility parameter value difference between the surface of the spacer particles and the liquid portion other than the spacer particle, and the solubility in solvent of an alignment layer were measured by the following method. The results are shown in Table 3.

### (Receding Contact Angle)

The receding contact angle was measured by observing a droplet ejected on a substrate in the following manner using an apparatus shown in FIG. 8. That is, Hirox digital microscope was transversely installed and a droplet was observed (output was digital data obtained by a monitor or a capture soft) from an approximately right side (slightly upper side [within 1 deg]) by setting 6 times magnification of the microscope and about 1300 times magnification in a screen, radiating light on the opposed side to the microscopic mirror from a light source while setting the sample between them, photographing the droplet in movie, taking the image in form of snapshot, and measuring the droplet diameter, contact angle, and amount by image analysis.

(Solubility Parameter Value Difference Between the Surface of the Spacer Particles and the Liquid Portion Other than the Spacer Particles)

The SP value of a solvent and a solvent mixture and the SP value of the spacer particle surface were calculated by calculation using parameters described in Table 3-3, Okitsu et al., “Adhesion”, vol. 40, no. 8, p. 342-350 (1996) (Polymer Publication Associate) and in the case of a solvent mixture, an expression of the reference (2.8) were employed and in the case of spacer particle surface, expressions (3.4) and (3.5) were employed.

The SP value of the solvent mixture was calculated in accordance with the mixing ratios of mixed solvents.

The SP value of the spacer particle surface was measured by analyzing the spacer surface by TOF-SIMS (time of flight secondary ion mass spectrometry), observing what kind copolymer of monomer units (the monomer types as the polymer-composing components), calculating the mole ratios of the monomer units (e.g. in the case of acrylic monomer, —CH₂—CHCOOR—) based on the measurement, and calculating the measurement values. That is, the SP value of the spacer particle surface was not calculated on the basis of the mixing amounts of the monomers used for producing the spacer or surface modification of the spacer. That is because even if the mixing ratios and amounts of the monomers are same, the chemical and physical state of the spacer surface differs in accordance with an initiator and polymerization method.

### (Solubility in Solvent of Alignment Layer)

The measurement was carried out as follows: after the spacer particle dispersion in an amount equivalent to 100 mg of solid matter was vacuum dried at 90° C. for 5 hours and 150° C. for 5 hours, the dried spacer particle dispersion was baked at 220° C. for 1 hour (in the case the dispersion contained a photosetting resin as the adhesive component, ultraviolet rays of 2500 mJ intensity were radiated), and the weight (Wa) of the cured product was measured and then the solid matter was separated by filtration, and while putting 10 g of N-methyl 2-pyrolidone and oscillating, leave it for 5 hours, and vacuum dried at 150° C. for 5 hours and the weight (Wb) was measured, and the solubility in the solvent of the alignment layer was defined as (Wa−Wb)/Wa.

### (2) Evaluation of Arrangement of Spacer Particles

With respect to the color filter model substrate on which the spacer particles are arranged, the following properties were measured: the number of the spacer particles arranged on a substrate (the maximum, the minimum, and the average number in one arrangement position were measured by averaging these values in 100 arrangement positions), the variation (standard deviation) (measured at the time of the concentration of the adhesive component of 0.3% by weight) of the gap between the uppermost parts of the spacer particles and the substrate, the cohesive power of the spacer particles, 10% deformation stress, the restoration ratio of the spacer particles, and arrangement ratio in a light-blocking region. The cohesive power of the spacer particles, 10% deformation stress, the restoration ratio of the spacer particles, and arrangement ratio in a light-blocking region were measured by the following methods. The results are shown in Table 4.

### (Cohesive Power of Spacer Particles)

A contactor was scanned on the substrate in the contact state while applying a constant and very small load to the substrate by a nano-scratch tester (manufactured by Nanotech Cooperation) and brought into contact with the spacer particles agglomerated and fixed with an adhesive. The cohesive power of the spacer particles was defined as the value calculated by dividing the power at a moment when the spacer particles moved by the number of the spacer particles. The cohesive power of the spacer particles deposited by conventional dry spraying was lower than 0.2 (μN/particle) [lower then detection limit] and in the case of the spacer particles deposited by ejecting the surface-treated spacer particle dispersion without any adhesive by an ink-jet apparatus was about 1 (μN/particle) and in the case of the invention, it was 5 (μN/particle) or higher.

### (10% Deformation Stress)

The 10% deformation stress was measured as follows: at 10 arrangement positions, the stress at the moment of 10% deformation was measured by a 100 μm contactor of a micro hardness meter (manufactured by Shimadzu Corp.). The stress was measured for every arrangement position and the value was calculated by dividing the stress by the number of the spacer particles existing at the arrangement position and an average value was defined as the 10% deformation stress.

### (Restoration Ratio of Spacer Particles)

At 10 arrangement positions respectively, a load calculated by multiplying 9.8 (mN) by the number of the spacer particles existing at every arrangement position was applied for 1 second and the alteration of the distance between the substrate and the uppermost part of the spacer particles (the points of the spacer particles most apart from the substrate) was measured before and after the load application. The average of the values calculated by dividing the distance after the load application by the distance before the load application for 10 arrangement positions was defined as the restoration ratio.

Restoration ratio=average value of (distance after load application/distance before load application)

### (Arrangement Ratio in Light-Blocking Region)

The test was carried out according to the method of a vibration test of the liquid crystal display device: JIS C 0040 (Shock vibration (acceleration SOG (9 m·s)) and 5 minute vibration with sinusoidal wave (0.1 KHz 30G, 1 KHz 30G). An example of the light-blocking region: a black matrix (the color filter side substrate), wiring (array side substrate).

### (3) Evaluation of Liquid Crystal Display Device

With respect to the liquid crystal display device, the alteration ratio of the volume resistivity of the liquid crystal and the alteration of the NI point were evaluated as follows. The results are shown in Table 5. (Alteration ratio of volume resistivity of liquid crystal)

The spacer particle dispersion was ejected to a glass substrate with a size of 100×100 mm to arrange the spacer particles on the substrate and baked at 220° C. for 1 hour (in the case the dispersion contains a photosetting resin as the adhesive component, ultraviolet ray radiation of 2500 mJ was performed) and an alignment layer (SE-7492, manufactured by Nissan Chemical Industries, Ltd.) was formed and fired at 220° C. for 2 hours. After that, the substrate was washed with water and dried at 105° C. for 30 minutes and successively 0.5 g of a liquid crystal (Chisso Lixon JC5007LA) was bought into contact. Using a resistivity measurement apparatus manufactured by Toyo Cooperation, the volume resistivity was measured in condition of 5V and 25° C. and the alteration ratio of the volume resistivity was calculated according to the following equation. As the alteration ratio of the volume resistivity is closer to 100%, it can be said that the contamination is less.

Alteration ratio of the volume resistivity=(volume resistivity of the liquid crystal after the test)/(volume resistivity of the liquid crystal before the test)×100(%)

### (NI Point Alteration)

The nematic-isotropic phase transition temperature (NI point) was measured at 10° C./min scanning in a temperature range from 0 to 110° C. by using a DSC apparatus and the alteration of the nematic-isotropic phase transition temperature (NI point) was calculated.

Alteration of NI point−(NI point before the test)−(NI point after the test)

### EXPERIMENTAL EXAMPLE 1

### Preparation of Color Filter Model Substrate

The duration of the water-repelling treatment of the color filter model substrate used in Example 1 was prolonged. The surface tension of the obtained color filter model substrate was 25.2 mN/m.

After that, production of a liquid crystal display device was carried out in the same manner as Example 1. Although the spacer particles were arranged in a narrow region than the deposited droplet diameter of the spacer particle dispersion on the substrate, overlaying of the particles was observed. Further, the color filter model substrate produced in this Experimental Example 1 was evaluated in the same manner as in Example 1. The results are shown in Table 3 and Table 4.

### EXPERIMENTAL EXAMPLE 2

### Preparation of Color Filter Model Substrate

No water-repelling treatment of the color filter model substrate used in Example 1 was carried out. The surface tension of the obtained color filter model substrate was 45.2 mN/m.

After that, production of a liquid crystal display device was carried out in the same manner as Example 1. The spacer particles were arranged in the approximately same region as the deposited droplet diameter of the spacer particle dispersion on the substrate. Further, the color filter model substrate produced in this Experimental Example 1 was evaluated for the items same as those in Example 1. The results are shown in Table 3 and Table 4.

TABLE 3

| | spacer particle | | | receding | | | | | | | solubility in |
|---|---|---|---|---|---|---|---|---|---|---|---|
| | dispersion | | surface | contact | viscosity | | specific | SP value (cal/cm³)^{1/2} | | | solvent of |
| | (types of spacer | | tension | angle | at 25° C. | specific | gravity | spacer | | | alignment layer |
| | particles) | | (mN/m) | (degree) | (mPa · s) | gravity | difference* | surface | solvent mixture | difference** | (%) |
| Example 1 | adhesive | SA | 32.0 | 42 | 15.0 | 1.18 | 0.05 | 13.1 | 10.3 | 2.8 | 1 |
| | component | SB | 32.1 | 48 | 15.0 | 1.18 | 0.05 | 11 | 10.3 | 0.7 | 1 |
| | solution A | SC | 32.1 | 45 | 15.1 | 1.18 | 0.05 | 10.5 | 10.3 | 0.2 | 1 |
| | | SD | 32.3 | 46 | 15.0 | 1.18 | 0.05 | 10.4 | 10.3 | 0.1 | 1 |
| | adhesive | SA | 35.1 | 49 | 6.4 | 1.14 | 0.01 | 13.1 | 11.9 | 1.2 | 1 |
| | component | SB | 35.2 | 40 | 6.5 | 1.14 | 0.01 | 11 | 11.9 | 0.9 | 1 |
| | solution B | SC | 35.1 | 49 | 6.3 | 1.14 | 0.01 | 10.5 | 11.9 | 1.4 | 1 |
| | | SD | 35.4 | 48 | 6.5 | 1.14 | 0.01 | 10.4 | 11.9 | 1.5 | 1 |
| | adhesive | SA | 44.2 | 55 | 6.7 | 1.15 | 0.02 | 13.1 | 11.7 | 1.4 | 1 |
| | component | SB | 43.3 | 54 | 6.5 | 1.15 | 0.02 | 11 | 11.7 | 0.7 | 1 |
| | solution C | SC | 45.2 | 50 | 6.6 | 1.15 | 0.02 | 10.5 | 11.7 | 1.2 | 1 |
| | | SD | 42.3 | 58 | 6.4 | 1.15 | 0.02 | 10.4 | 11.7 | 1.3 | 1 |
| | adhesive | SA | 40.1 | 49 | 8.9 | 1.1 | 0.03 | 13.1 | 11.7 | 1.4 | 1 |
| | component | SB | 40.2 | 52 | 8.7 | 1.1 | 0.03 | 11 | 11.7 | 0.7 | 1 |
| | solution D | SC | 40.3 | 48 | 8.8 | 1.1 | 0.03 | 10.5 | 11.7 | 1.2 | 1 |
| | | SD | 40.0 | 53 | 8.9 | 1.1 | 0.03 | 10.4 | 11.7 | 1.3 | 1 |
| Experiment 1 | adhesive | SA | 32.0 | 85 | 15.0 | 1.18 | 0.05 | 13.1 | 10.3 | 2.8 | 1 |
| | component | | | | | | | | | | |
| | solution A | | | | | | | | | | |
| Experiment 2 | adhesive | SA | 32.0 | <5 | 15.0 | 1.18 | 0.05 | 13.1 | 10.3 | 2.8 | 1 |
| | component | | | | | | | | | | |
| | solution A | | | | | | | | | | |

*difference of the specific gravity of the spacer to the specific gravity of the liquid portion other than the spacer
**difference (absolute value): |(spacer surface SP value) − (solvent mixture SP value)|

TABLE 4

| | | | | | | | | variation of | | | | | |
|---|---|---|---|---|---|---|---|---|---|---|---|---|---|
| | | | | | | | | the distance | | | | | |
| | | | | | | | | from the | | | | | |
| | | | | | | | | uppermost | | | | | |
| | | | | | | | | parts of the | | | | | |
| | | | | | | | | adhesive | | | | | |
| | | | | | | | | component | | | | | |
| | | | | | | | | deposited | | | | | |
| | | | | | | | variation of the | on the | | | | | |
| | | | | | | | distance from | spacer to the | cohe- | | | | |
| | | | | | | average | the uppermost | upper most | sive | | | | |
| | | | the number of | | | value of | parts of the | part of the | power | | | arrangement ratio | |
| | | | spacer particles | | | the | upper most | substrate | of | 10% | | in light-blocking | |
| | spacer particle | | arranged on the | | | sprayed | parts of spacer | (μm) | spacer | defor- | | region (%) | |
| | dispersion | | substrate (particle) | | | density | particles (μm) | (standard | particles | mation | spacer | before | after |
| | (types of spacer | | average | maxi- | mini- | (particle/ | (standard | deviation | (μN/ | stress | restoration | vibration | vibration |
| | particles) | | value | mum | mum | mm²) | deviation (%)) | (%)) | particle) | (mN) | ratio (%) | test | test |
| Exam- | adhesive | SA | 3.1 | 12 | 0 | 200 | 0.20 (5.0) | 0.30 (7.4) | 5.0 | 1.7 | 75 | 95 | 95 |
| ple 1 | component | SB | 3.1 | 13 | 1 | 205 | 0.18 (4.5) | 0.20 (4.9) | 5.0 | 1.3 | 75 | 97 | 96 |
| | solution A | SC | 3.0 | 11 | 0 | 195 | 0.20 (5.0) | 0.28 (6.9) | 5.0 | 1.5 | 75 | 95 | 95 |
| | | SD | 3.2 | 14 | 1 | 210 | 0.22 (5.5) | 0.38 (9.3) | 5.0 | 1.5 | 75 | 92 | 90 |
| | adhesive | SA | 3.0 | 13 | 0 | 195 | 0.20 (5.0) | 0.30 (7.4) | 5.0 | 1.7 | 75 | 95 | 95 |
| | component | SB | 3.1 | 13 | 1 | 205 | 0.21 (5.2) | 0.28 (6.9) | 5.0 | 1.3 | 75 | 96 | 96 |
| | solution B | SC | 3.1 | 11 | 0 | 200 | 0.19 (4.7) | 0.37 (9.1) | 5.0 | 1.4 | 75 | 95 | 94 |
| | | SD | 3.2 | 15 | 1 | 210 | 0.22 (5.5) | 0.30 (7.4) | 5.0 | 1.5 | 75 | 96 | 94 |
| | adhesive | SA | 3.0 | 13 | 0 | 195 | 0.19 (4.7) | 0.30 (7.4) | 5.0 | 1.5 | 75 | 95 | 95 |
| | component | SB | 3.2 | 15 | 1 | 210 | 0.21 (5.2) | 0.30 (7.4) | 5.0 | 1.4 | 75 | 96 | 96 |
| | solution C | SC | 3.1 | 11 | 0 | 200 | 0.18 (4.5) | 0.28 (6.9) | 5.0 | 1.3 | 75 | 95 | 94 |
| | | SD | 3.1 | 14 | 1 | 205 | 0.22 (5.5) | 0.37 (9.1) | 5.0 | 1.4 | 75 | 96 | 94 |
| | adhesive | SA | 3.2 | 15 | 1 | 210 | 0.20 (5.0) | 0.28 (6.9) | 5.0 | 1.6 | 75 | 95 | 95 |
| | component | SB | 3.1 | 13 | 1 | 205 | 0.19 (4.7) | 0.37 (9.1) | 5.0 | 1.3 | 75 | 96 | 96 |
| | solution D | SC | 3.1 | 12 | 0 | 200 | 0.21 (5.2) | 0.30 (7.4) | 5.0 | 1.4 | 75 | 95 | 94 |
| | | SD | 3.0 | 13 | 0 | 195 | 0.22 (5.5) | 0.30 (7.4) | 5.0 | 1.7 | 75 | 96 | 94 |
| Exper- | adhesive | SA | 3.0 | 11 | 0 | 195 | 0.80 (20.0) | 0.82 (20.5) | 5.0 | 1.4 | 70 | 95 | 95 |
| iment 1 | component | | | | | | | | | | | | |
| | solution A | | | | | | | | | | | | |
| Exper- | adhesive | SA | 3.0 | 11 | 0 | 195 | 0.20 (5.0) | 0.28 (4.9) | 5.0 | 1.7 | 75 | 65 | 65 |
| iment 2 | component | | | | | | | | | | | | |
| | solution A | | | | | | | | | | | | |

*Variation (standard deviation (%)) of the distance from the uppermost parts of the adhesive component deposited on the upper part of the spacer (the parts most apart from the substrate) to the substrate was measured when the adhesive component concentration became 0.3% by
**The maximum, the minimum, and the average number in one arrangement position were measured by averaging these values in 100 arrangement positions.

TABLE 5

| | | |
|---|---|---|
| spacer particle | alteation ratio | |
| dispersion (types of | of volume resistivity | alteration of |
| the spacer particles) | of liquid crystal (%) | NI point (° C.) |

| | | | |
|---|---|---|---|
| adhesive | SA | 50 | 0.02 |
| component | SB | 59 | 0.03 |
| soluion A | SC | 40 | 0.01 |
| | SD | 36 | 0.04 |
| adhesive | SA | 30 | 0.02 |
| component | SB | 54 | 0.02 |
| soluion B | SC | 59 | 0.04 |
| | SD | 62 | 0.01 |
| adhesive | SA | 43 | 0.01 |
| component | SB | 50 | 0.04 |
| soluion C | SC | 39 | 0.01 |
| | SD | 58 | 0.02 |
| adhesive | SA | 32 | 0.01 |
| component | SB | 45 | 0.02 |
| soluion D | SC | 42 | 0.03 |
| | SD | 39 | 0.01 |

### EXPERIMENTAL EXAMPLE 3

A spacer particle dispersion was produced in the same manner as the method of obtaining the spacer particle dispersion from the adhesive component solution A in Example 1, except that a spacer for which the surface treatment was not carried out was used and various evaluations same as those in Example 1 were carried out for the spacer particle dispersion.

As a result, similar results to those of Example 1 were obtained, however in the case the spacer particle dispersion was left still for 1 hour (not treated by stirring or ultrasonic radiation by a sonicator) and then the spacer particle dispersion was ejected again to a substrate and successively subjected to the evaluation, the average spraying density was decreased to 85 (particle/mm²) as compared with that in Example 1. When the cause was investigated, a large quantity of the agglomerates of the spacer particles were stuck to a filter attached upstream of the head of the ink-jet apparatus. On the other hand, in Example 1, even if the spacer particle dispersion was ejected after being left for 1 hour, the average spraying density was scarcely changed (10% or less alteration ratio) and accordingly, in the case of using the spacer which was not subjected to the surface treatment just like the case of Experimental Example 3, since the dispersibility was deteriorated, it is supposed to be necessary to carry out ultrasonic radiation. Actually, in the case the spacer particle dispersion which was left for 1 hour, dispersed again by ultrasonic radiation with a sonicator, and used within 5 minutes, the average spraying density was scarcely changed.

### EXPERIMENTAL EXAMPLE 4

A spacer particle dispersion was produced from the spacer particles SD in the same manner as the method in Example 1 of obtaining the adhesive component solution B, except that the solvent was changed to ethylene glycol diethyl ether (specific gravity: 0.842, viscosity: 0.7 mPa-s, boiling point: 121° C., and surface tension: 23.5 mN/m). (Additionally, different from other examples of Example 1, since the boiling points of MEK and ethylene glycol diethyl ether, which are solvents used for producing the adhesive component, are close, in order to completely remove MEK, steps of reducing pressure and adding ethylene glycol diethyl ether were repeated two times.) Using the spacer particle dispersion obtained in such a manner, various evaluations same as those in Example 1 were carried out.

As a result, similar results to those of Example 1 were obtained, however in the case the spacer particle dispersion was left still for 1 hour (not treated by stirring or ultrasonic radiation by a sonicator) and then the spacer particle dispersion was ejected again to a substrate and successively subjected to the evaluation, the average spraying density was decreased to 65 (particle/mm²) as compared with that in Example 1. When the cause was investigated, the spacer was settled in the bottom of a container for storing the spacer particle dispersion and the concentration in the upper part was decreased. On the other hand, in Example 1, even if the spacer particle dispersion was ejected after being left for 1 hour, the average spraying density was scarcely changed (10% or less alteration ratio) and accordingly, in the case the specific gravity difference is high (specific gravity difference: 0.29) as just like the case of Experimental Example 4, it is supposed that the spacer particle dispersion in a container has to be stirred constantly. Actually, in the case the spacer particle dispersion which was left for 1 hour while being stirred and used again (the stirring was carried out during the ejecting process), the average spraying density was scarcely changed.

### EXPERIMENTAL EXAMPLE 5

A spacer particle dispersion was produced from the spacer particles SD in the same manner as the method in Example 1 of obtaining the adhesive component solution B, except that a mixture of water and glycerin was used as the solvent (the adhesive component solution was E and water was added after MEK was removed by reducing the pressure). The physical properties of the raw materials composing the solvents contained in the obtained adhesive component solution are shown in Table 2. Using the obtained spacer particle dispersion, various evaluations same as those in Example 1 were carried out.

As a result, similar results to those of Example 1 were obtained, however in the case the spacer particle dispersion was left still for 1 hour (not treated by stirring or ultrasonic radiation by a sonicator) and then the spacer particle dispersion was ejected again to a substrate and successively subjected to the evaluation, the average spraying density was decreased to 80 (particle/mm²) as compared with that in Example 1. When the cause was investigated, a large quantity of the agglomerates of the spacer particles were stuck to a filter attached upstream of the head of the ink-jet apparatus. On the other hand, in Example 1, even if the spacer particle dispersion was ejected after being left for 1 hour, the average spraying density was scarcely changed (10% or less alteration ratio) and accordingly, in the case the difference of SP value of the solvent from that of the spacer particles is wide (7.0) just like this Example, since the dispersibility was deteriorated, it is supposed to be necessary to carry out ultrasonic radiation. Actually, in the case the spacer particle dispersion which was left for 1 hour, dispersed again by ultrasonic radiation with a sonicator, and used within 5 minutes, the average spraying density was scarcely changed.

### EXAMPLE 2

### Preparation of Copolymer

A hundred g of a monomer mixture containing glycidyl acrylate 40 mol % and n-butyl methacrylate 60 mol % was dissolved in 300 g of diethylene glycol dimethyl ether and the obtained solution was fed to a separable flask and after replacement with nitrogen, while 10 g of a diethylene glycol dimethyl ether solution containing 10% by weight of an oil-soluble azo type polymerization initiator (trade name: V-65, manufactured by Wako Pure Chemical Industries, Ltd.) was dropwise added for 2 hours, polymerization reaction was carried out.

After that, the obtained diethylene glycol dimethyl ether solution was dropwise added to a large quantity of methanol to coagulate the reaction product. The coagulated product was washed with water and successively dissolved again in 300 g of tetrahydrofuran and again dropwise added to a large quantity of methanol to obtain coagulated product. The re-dissolution/coagulation was repeated three times and the obtained coagulated product was vacuum dried at 45° C. for 48 hours to obtain an aimed copolymer (A1).

### (Preparation of Copolymerization Solution)

After 20 g of the obtained copolymer (A1) was dissolved in 80 g of diethyl phthalate, the solution was filtered by a stainless mesh with 10 μm aperture to obtain a copolymer solution (1).

### (Preparation of Spacer Particle Dispersion)

Spacer particles (trade name: Micropearl, manufactured by Sekisui Chemical Co., Ltd.) in a necessary amount to adjust a prescribed particle concentration (0.5% by weight) were slowly added to the copolymer solution (1) which was diluted to have a prescribed copolymer component concentration (0.5% by weight) and dispersed by sufficiently stirring with a sonicator. After being mixed with trimellitic acid 15 parts by weight as the (B) component, the obtained solution 125 parts by weight was filtered by a stainless mesh with 10 μm aperture to remove agglomerates and obtain a spacer particle dispersion (1).

### (Preparation of Substrates)

### (1) Preparation of Color Filter Model Substrate

A black matrix of metal chromium (width 25 μm, longitudinal intervals 150 μm, transverse intervals 75 μm, and thickness 0.2 μm) was formed on a glass substrate by a common method. Pixels of a color filter (thickness 1.5 μm) comprising three colors of red, green, and blue were formed on and in the black matrix in a manner that the surface became flat. An overcoat layer with an approximately constant thickness and an ITO transparent electrode were formed thereon. Further, water-repelling treatment was carried out using CF₄/N₂ gas mixture by “Normal pressure plasma surface treatment apparatus” manufactured by Sekisui Chemical Co., Ltd.) to prepare a color filter model substrate. The surface tension of the color filter model substrate was 27.4 mN/m.

### (2) Preparation of TFT Array Model Opposed Substrate

A black matrix of metal chromium (width 25 μm, longitudinal intervals 150 μm, transverse intervals 75 μm, and thickness 0.2 μm) was formed on a glass substrate by a common method. Pixels of a color filter (thickness 1.5 μm) comprising three colors of red, green, and blue were formed on and in the black matrix in a manner that the surface became flat. Next, a step (width 8 μm and height difference 5 nm) of copper was formed at position corresponding to the black matrix on a glass substrate by a conventionally known method. An ITO transparent electrode with a constant thickness was formed thereon.

Further, a polyimide resin solution (Sunever SE1211, manufactured by Nissan Chemical Industries, Ltd.) was evenly applied to the substrate by a spin coating method. After the application, the solution was dried at 80° C. and fired at 210° C. for 1 hour for curing to form an alignment layer with an approximately constant thickness and accordingly prepare a TFT array model substrate.

The surface tension of the formed alignment layer was 30.2 mN/m.

### (Preparation of Ink-Jet Apparatus)

An ink-jet apparatus equipped with a piezoelectric type head with an aperture diameter of 50 μm was made available. The liquid contact part of the ink chamber of the head was made of a glass ceramic material. The nozzle faces were subjected to water-repelling treatment with a fluoro material.

### (Arrangement of Spacer Particles)

Using the obtained spacer particle dispersion (1), the spacer particles were arranged on the color filter model substrate by an ink-jet apparatus. At the time of arrangement of the spacer particles, 0.5 mL of the spacer particle dispersion ejected initially out of the nozzles of the ink-jet apparatus was discarded and then the arrangement was started.

At first, the substrate was put on a stage heated to 45° C. by a heater. Using the above-mentioned ink-jet apparatus, droplets of the spacer particle dispersion were ejected and arranged at 110 μm longitudinal×150 μm transverse pitches on every other longitudinal lines at 110 μm intervals and dried. The gap between the nozzle tip ends and the substrate was 0.5 mm at the time of ejecting and a double pulse method was employed for ejecting.

After ejecting, the droplets were dried at 90° C. to evaporate the solvent and thereafter baked at 220° C. for 1 hour to cure the adhesive component.

After that, the color filter model substrate on which the spacer particles were arranged was subjected to water-repelling treatment by corona treatment (the initial contact angle of the following polyimide resin solution to the substrate immediately after the treatment was 0 degree) and successively the polyimide resin solution (Sunever SE1211, manufactured by Nissan Chemical Industries, Ltd.) was evenly applied to the substrate by a spin coating method. After the application, the solution was dried at 80° C. and fired at 210° C. for 1 hour for curing to form an alignment layer with an approximately constant thickness.

### (Completion of Liquid Crystal Display Device)

The color filter model substrate on which spacer particles were arranged and the TFT array model substrate, which was a counter substrate, were stuck to each other using a circumferential seal agent. After the sticking, the seal agent was heated at 150° C. for 1 hour for curing to produce an empty cell having a cell gap equal to the particle diameter of the spacer particles and successively the cell was filled with a liquid crystal by a vacuum method and an injection port was sealed with a sealing agent to produce a liquid crystal display device.

### (Evaluation)

### (1) Adhesive Material Evaluation

### (i) Solvent Resistance

After the polyimide resin solution (Sunever SE1211, manufactured by Nissan Chemical Industries, Ltd.) was evenly applied to an adhesive material-fixed spacer particles arranged on the color filter model substrate by a spin coating method, the number of the separated spacer particles (/100 particles) was investigated. The results are shown in Table 6.

### (ii) Heat Resistance

The weight decrease ratio of the adhesive material-fixed spacer particles after the adhesive component was baked at 220° C. for 1 hour was evaluated. The results are shown in Table 6.

### (2) Evaluation of Arrangement of Spacer Particles

With respect to the color filter model substrate on which the spacer particles were arranged, the following evaluations were carried out: the number of spacer particles arranged on the substrate, 15% deformation stress, restoration ratio of the spacer, arrangement ratio in a light-blocking region (before and after vibration test (Shock vibration (acceleration SOG (9 ms)), and 5 minute vibration with sinusoidal wave (0.1 KHz 30G, 1 KHz 30G).

The measurement of the 15% deformation stress was calculated from a load for causing 15% strain of spacer particles on a smooth end face of a column having 50 μm diameter by a micro hardness meter (HP-100, manufactured by Fisher Instrument).

The restoration ratio was calculated according to the following equation from the displacement degree measured before and after releasing a load, after keeping the spacer particles in 15% deformation state for 5 seconds and releasing the load.

Restoration ratio(%)=(displacement degree measured before releasing the load)/(displacement degree measured before releasing the load−displacement degree measured after releasing the load)×100

For the evaluation of the 15% deformation stress and the restoration ratio of the spacer particles, agglomerates formed by gathering 7 spacer particles were employed as the objects. The results are shown in Table 6.

### (3) Evaluation of Liquid Crystal Display Device

With the liquid crystal display device, the alteration ratio of the volume resistivity of the liquid crystal and the alteration of the NI point were measured.

With respect to the alteration ratio of volume resistivity of liquid crystal, the spacer particle dispersion was ejected to a glass substrate with a size of 100×100 mm to arrange the spacer particles on the substrate and baked at 220° C. for 1 hour and an alignment layer (SE-7492, manufactured by Nissan Chemical Industries, Ltd.) was formed by coating and fired at 220° C. for 2 hours. After that, the substrate was washed with water and dried at 105° C. for 30 minutes and successively 0.5 g of a liquid crystal (Chisso Lixon JC5007LA) was bought into contact. Using a resistivity measurement apparatus manufactured by Toyo Cooperation, the volume resistivity was measured in condition of 5V and 25° C. and the alteration ratio of the volume resistivity was calculated according to the following equation.

Alteration ratio of the volume resistivity=(volume resistivity of the liquid crystal after the test)/(volume resistivity of the liquid crystal before the test)×100(%)

On the other hand, with respect to the NI point alteration, the nematic-isotropic phase transition temperature (NI point) was measured at 10° C./min scanning in a temperature range from 0 to 110° C. by using a DSC apparatus and the alteration of the nematic-isotropic phase transition temperature (NI point) was calculated according to the following equation.

Alteration of NI point=(NI point before the test)−(NI point after the test)

The results are shown in Table 6.

### EXAMPLE 3

### Preparation of Copolymer

At first, 100 g of a monomer mixture comprising glycidyl acrylate 80 mol % and n-butyl acrylate 20 mol % was dissolved in 300 g of diethylene glycol dimethyl ether and the obtained solution was fed to a separable flask and after replacement with nitrogen, while 10 g of a diethylene glycol dimethyl ether solution containing 10% by weight of an oil-soluble azo type polymerization initiator (trade name: V-65, manufactured by Wako Pure Chemical Industries, Ltd.) was dropwise added for 2 hours, polymerization reaction was carried out.

After that, a copolymer (A2) was obtained in the same manner as Example 2. A copolymer solution (2) and a spacer particle dispersion (2) were obtained in the same manner as Example 2, except the obtained copolymer (A2) was used in place of the copolymer (A1).

With respect to the obtained spacer particle dispersion (2), the same evaluations as those in Example 2 were carried out. The results are shown in Table 6.

### EXAMPLE 4

### Preparation of Copolymer

At first, 100 g of a monomer mixture comprising glycidyl acrylate 40 mol % and methyl methacrylate 60 mol % was dissolved in 300 g of diethylene glycol dimethyl ether and the obtained solution was fed to a separable flask and after replacement with nitrogen, while 10 g of a diethylene glycol dimethyl ether solution containing 10% by weight of an oil-soluble azo type polymerization initiator (trade name: V-65, manufactured by Wako Pure Chemical Industries, Ltd.) was dropwise added for 2 hours, polymerization reaction was carried out.

After that, a copolymer (A3) was obtained in the same manner as Example 2. A copolymer solution (3) and a spacer particle dispersion (3) were obtained in the same manner as Example 2, except the obtained copolymer (A3) was used in place of the copolymer (A1).

With respect to the obtained spacer particle dispersion (3), the same evaluations as those in Example 2 were carried out. The results are shown in Table 6.

### EXAMPLE 5

### Preparation of Spacer Particle Dispersion

Spacer particles (trade name: Micropearl, manufactured by Sekisui Chemical Co., Ltd.) in a necessary amount to adjust a prescribed particle concentration (0.5% by weight) were slowly added to the copolymer solution (1) which was diluted to have a prescribed copolymer component concentration (0.5% by weight) and dispersed by sufficiently stirring with a sonicator. After being mixed with trimellitic acid 15 parts by weight, the obtained solution 125 parts by weight was filtered by a stainless mesh with 10 μm aperture to remove agglomerates and obtain a spacer particle dispersion (4).

With respect to the obtained spacer particle dispersion (4), the same evaluations as those in Example 2 were carried out. The results are shown in Table 6.

### EXAMPLE 6

### Preparation of Spacer Particle Dispersion

Spacer particles (trade name: Micropearl, manufactured by Sekisui Chemical Co., Ltd.) in a necessary amount to adjust a prescribed particle concentration (0.5% by weight) were slowly added to the copolymer solution (2) which was diluted to have a prescribed copolymer component concentration (0.5% by weight) and dispersed by sufficiently stirring with a sonicator. After being mixed with trimellitic acid 15 parts by weight, the obtained solution 125 parts by weight was filtered by a stainless mesh with 10 μm aperture to remove agglomerates and obtain a spacer particle dispersion (5).

With respect to the obtained spacer particle dispersion (5), the same evaluations as those in Example 2 were carried out. The results are shown in Table 6.

### (Experiment 6)

### Preparation of Copolymer

At first, 100 parts of a single monomer of 100 mol % of n-butyl acrylate was dissolved in 300 parts of diethylene glycol dimethyl ether and the obtained solution was fed to a separable flask and after replacement with nitrogen, while 10 parts of a diethylene glycol dimethyl ether solution containing 10% by weight of an oil-soluble azo type polymerization initiator (trade name: V-65, manufactured by Wako Pure Chemical Industries, Ltd.) was dropwise added for 2 hours, polymerization reaction was carried out.

After that, a copolymer (A6) was obtained in the same manner as Example 2. A copolymer solution (6) and a spacer particle dispersion (6) were obtained in the same manner as Example 2, except the obtained copolymer (A6) was used in place of the copolymer (A1).

With respect to the obtained spacer particle dispersion (6), the same evaluations as those in Example 2 were carried out. The results are shown in Table 6.

### (Experiment 7)

### (Preparation of Copolymer)

At first, 100 parts of a monomer mixture containing glycidyl acrylate 2 mol % and n-butyl acrylate 98 mol % was dissolved in 300 parts of diethylene glycol dimethyl ether and the obtained solution was fed to a separable flask and after replacement with nitrogen, while 10 parts of a diethylene glycol dimethyl ether solution containing 10% by weight of an oil-soluble azo type polymerization initiator (trade name: V-65, manufactured by Wako Pure Chemical Industries, Ltd.) was dropwise added for 2 hours, polymerization reaction was carried out.

After that, a copolymer (A7) was obtained in the same manner as Example 2. A copolymer solution (7) and a spacer particle dispersion (7) were obtained in the same manner as Example 2, except the obtained copolymer (A7) was used in place of the copolymer (A1).

With respect to the obtained spacer particle dispersion (7), the same evaluations as those in Example 2 were carried out. The results are shown in Table 6.

### COMPARATIVE EXAMPLE 1

The same evaluations were carried out in the same manner as those in Example 2, except that the spacer particle dispersion was prepared without using the copolymer component and trimellitic acid. The results are shown in Table 6.

TABLE 6

| | | | | | | | | | | alteration | | | |
|---|---|---|---|---|---|---|---|---|---|---|---|---|---|
| | | | | | number of | | | | | ratio | | | |
| | | | | | spacer particles | | | | | of volume | | arrangement ratio in | |
| | | cohesive | | | arranged on | | | 15% | | resistivity | alter- | light-blocking | |
| | receding | power of | | | the substrate | | | defor- | | of | ation | region (%) | |
| | contact | spacer | | | (particle/drop) | | | mation | spacer | liquid | of NI | before | after |
| | angle | particles | solvent | heat | maxi- | mini- | | stress | restration | crystal | point | vibration | vibration |
| | (degree) | (μN/particle) | resistance | resistance | mum | mum | average | (mN) | ratio (%) | (%) | (° C.) | test | test |
| Example 2 | 45 | 5.0 | 0 | −4% | 19 | 0 | 7.1 | 26.1 | 94 | 36 | 0.02 | 95 | 95 |
| Example 3 | 46 | 5.0 | 0 | −2% | 19 | 0 | 7.1 | 27.3 | 95 | 40 | 0.03 | 97 | 97 |
| Example 4 | 44 | 5.0 | 0 | −1% | 18 | 0 | 7.2 | 27.5 | 95 | 39 | 0.02 | 95 | 95 |
| Example 5 | 48 | 5.0 | 0 | −3% | 20 | 0 | 7.2 | 25.9 | 93 | 46 | 0.02 | 96 | 96 |
| Example 6 | 45 | 5.0 | 0 | −2% | 19 | 0 | 7.1 | 25.6 | 94 | 44 | 0.02 | 96 | 96 |
| Exper- | 41 | 5.0 | entirely | −35% | 18 | 0 | 7.0 | 24.1 | 91 | 14 | 0.57 | — | — |
| iment 6 | | | separated | | | | | | | | | | |
| Exper- | 42 | 5.0 | 3 | −15% | 19 | 0 | 7.1 | 24.6 | 82 | 16 | 0.22 | 95 | 60 |
| iment 7 | | | | | | | | | | | | | |
| Com- | 41 | 1.0 | entirely | — | 18 | 0 | 7.0 | 14.1 | 92 | 14 | 0.03 | — | — |
| parative | | | separated | | | | | | | | | | |
| Example 1 | | | | | | | | | | | | | |

*In Comparative Example 1, the dispersion obtained in the same manner as Example 2, except the adhesive component and trimellitic acid were not added, was used.

From Table 6, the spacer particle dispersions of Examples 2 to 6 were found having solvent resistance enough to stand alignment layer application and their weight alteration ratios by heating were suppressed to 4% or lower and on the other hand, the spacer particle dispersions of Experiments 6 and 7 and Comparative Example 1 showed apparently inferior solvent resistance and heat resistance.

In Examples 2 to 6, no spacer movement was observed by the vibration test, however spacer movement out of the light-blocking region occurred in Experiments 6 and 7 and Comparative Example 1.

### EXAMPLE 7

### Preparation of Copolymer

At first, 117.7 parts of a monomer mixture comprising n-butyl acrylate 60 mol %, glycidyl acrylate 20 mol % and acrylic acid 20 mol % was dissolved in 352.9 parts of diethylene glycol dimethyl ether and the obtained solution was fed to a separable flask and after replacement with nitrogen, while 11.8 parts of a diethylene glycol dimethyl ether solution containing 10% by weight of an oil-soluble azo type polymerization initiator (trade name: V-65, manufactured by Wako Pure Chemical Industries, Ltd.) was dropwise added for 2 hours, polymerization reaction was carried out.

After that, the obtained diethylene glycol dimethyl ether solution was dropwise added to a large quantity of methanol to coagulate the reaction product. The coagulated product was washed with water and successively dissolved in 200 g of tetrahydrofuran and again dropwise added to a large quantity of methanol to obtain coagulated product. After the re-dissolution/coagulation process was repeated three times, the obtained coagulated product was vacuum dried at 45° C. for 48 hours to obtain an aimed copolymer (8).

### (Preparation of Copolymerization Solution)

After 20 g of the obtained copolymer (8) was dissolved in 80 g of diethyl phthalate, the solution was filtered by a stainless mesh with 10 μm aperture to obtain a copolymer solution (8).

### (Preparation of Spacer Particle Dispersion)

Spacer particles (trade name: Micropearl, manufactured by Sekisui Chemical Co., Ltd.) in a necessary amount to adjust a prescribed particle concentration (0.5% by weight) were slowly added to the copolymer solution which was diluted to have a prescribed copolymer component concentration (0.5% by weight) and dispersed by sufficiently stirring with a sonicator, and after that, the obtained solution was filtered by a stainless mesh with 10 μm aperture to remove agglomerates and obtain a spacer particle dispersion (8).

### (Preparation of Substrates)

### (1) Preparation of Color Filter Model Substrate

A black matrix of metal chromium (width 25 μm, longitudinal intervals 150 μm, transverse intervals 75 μm, and thickness 0.2 μm) was formed on a glass substrate by a common method. Pixels of a color filter (thickness 1.5 μm) comprising three colors of red, green, and blue were formed on and in the black matrix in a manner that the surface became flat. An overcoat layer with an approximately constant thickness and an ITO transparent electrode were formed thereon. Further, water-repelling treatment was carried out using CF₄/N₂ gas mixture by “Normal pressure plasma surface treatment apparatus” manufactured by Sekisui Chemical Co., Ltd.) to prepare a color filter model substrate.

The surface tension of the color filter model substrate was 27.4 mN/m.

### (2) Preparation of TFT Array Model Opposed Substrate

A black matrix of metal chromium (width 25 μm, longitudinal intervals 150 μm, transverse intervals 75 μm, and thickness 0.2 μm) was formed on a glass substrate by a common method. Pixels of a color filter (thickness 1.5 μm) comprising three colors of red, green, and blue were formed on and in the black matrix in a manner that the surface became flat. Next, a step (width 8 μm and height difference 5 nm) of copper was formed at position corresponding to the black matrix on a glass substrate by a conventionally known method. An ITO transparent electrode with a constant thickness was formed thereon.

Further, a polyimide resin solution (Sunever SE1211, manufactured by Nissan Chemical Industries, Ltd.) was evenly applied to the substrate by a spin coating method. After the application, the solution was dried at 80° C. and fired at 210° C. for 1 hour for curing to form an alignment layer with an approximately constant thickness and accordingly prepare a TFT array model substrate.

The surface tension of the formed alignment layer was 30.2 mN/m.

### (Preparation of Ink-Jet Apparatus)

An ink-jet apparatus equipped with a piezoelectric type head with an aperture diameter of 50 μm was made available. The liquid contact part of the ink chamber of the head was made of a glass ceramic material. The nozzle faces were subjected to water-repelling treatment with a fluoro material.

### (Arrangement of Spacer Particles)

Using the obtained spacer particle dispersion (8), the spacer particles were arranged on the color filter model substrate by an ink-jet apparatus. At the time of arrangement of the spacer particles, 0.5 mL of the spacer particle dispersion ejected initially out of the nozzles of the ink-jet apparatus was discarded and then the arrangement was started.

At first, the substrate was put on a stage heated to 45° C. by a heater. Using the above-mentioned ink-jet apparatus, droplets of the spacer particle dispersion were ejected and arranged at 110 μm longitudinal×150 μm transverse pitches on every other longitudinal lines at 110 μm intervals and dried. The gap between the nozzle tip ends and the substrate was 0.5 mm at the time of ejecting and a double pulse method was employed for ejecting.

After ejecting, the droplets were dried at 90° C. to evaporate the solvent and thereafter baked at 220° C. for 1 hour to cure the adhesive component.

After that, the color filter model substrate on which the spacer particles were arranged was subjected to water-repelling treatment by corona treatment (the initial contact angle of the following polyimide resin solution to the substrate immediately after the treatment was 0 degree) and successively the polyimide resin solution (Sunever SE1211, manufactured by Nissan Chemical Industries, Ltd.) was evenly applied to the substrate by a spin coating method. After the application, the solution was dried at 80° C. and fired at 210° C. for 1 hour for curing to form an alignment layer with an approximately constant thickness.

### (Completion of Liquid Crystal Display Device)

The color filter model substrate on which spacer particles were arranged and the TFT array model substrate, which was a counter substrate, were stuck to each other using a peripheral seal agent. After the sticking, the seal agent was heated at 150° C. for 1 hour for curing to produce an empty cell having a cell gap equal to the particle diameter of the spacer particles and successively the cell was filled with a liquid crystal by a vacuum method and an injection port was sealed with a sealing agent to produce a liquid crystal display device.

### (Evaluation)

(1) Adhesive Material Evaluation

### (i) Solvent Resistance

After the polyimide resin solution (Sunever SE1211, manufactured by Nissan Chemical Industries, Ltd.) was evenly applied to an adhesive material-fixed spacer particles arranged on the color filter model substrate by a spin coating method, the number of the separated spacer particles (/100 particles) was investigated. The results are shown in Table 5.

### (ii) Heat Resistance

The weight decrease ratio of the adhesive material-fixed spacer particles after the adhesive component was baked at 220° C. for 1 hour was evaluated. The results are shown in Table 7.

(2) Storage Stability Evaluation of Spacer Particle Dispersion

The viscosity of the spacer particle dispersion was measured after heating at 40° C. for 300 hours. The case the viscosity alteration was 5% or less, ◯ was marked and the case it exceeded 5%, x was marked. The results are shown in Table 7.

(3) Evaluation of Arrangement of Spacer Particles

With respect to the color filter model substrate on which the spacer particles were arranged, the following evaluations were carried out: the number of spacer particles arranged on the substrate, 15% deformation stress, and restoration ratio of the spacer.

The measurement of the 15% deformation stress was calculated from a load for causing 15% strain of spacer particles on a smooth end face of a column having 50 μm diameter by a micro hardness meter (HP-100, manufactured by Fisher Instrument).

The restoration ratio was calculated according to the following equation from the displacement degree measured before and after releasing a load, after keeping the spacer particles in 15% deformation state for 5 seconds and releasing the load.

Restoration ratio(%)=(displacement degree measured before releasing the load)/(displacement degree measured before releasing the load−displacement degree measured after releasing the load)×100

For the evaluation of the 15% deformation stress and the restoration ratio of the spacer particles, agglomerates formed by gathering 7 spacer particles were employed. The results are shown in Table 7.

(4) Evaluation of Liquid Crystal Display Device

With the liquid crystal display device, the alteration ratio of the volume resistivity of the liquid crystal and the alteration of the NI point were measured.

With respect to the alteration ratio of volume resistivity of liquid crystal, the spacer particle dispersion was ejected to a glass substrate with a size of 100×100 mm to arrange the spacer particles on the substrate and baked at 220° C. for 1 hour and an alignment layer (SE-7492, manufactured by Nissan Chemical Industries, Ltd.) was formed by coating and fired at 220° C. for 2 hours. After that, the substrate was washed with water and dried at 105° C. for 30 minutes and successively 0.5 g of a liquid crystal (Chisso Lixon JC5007LA) was bought into contact. Using a resistivity measurement apparatus manufactured by Toyo Cooperation, the volume resistivity was measured in condition of 5V and 25° C. and the alteration ratio of the volume resistivity was calculated according to the following equation.

Alteration ratio of the volume resistivity=(volume resistivity of the liquid crystal after the test)/(volume resistivity of the liquid crystal before the test)×100(%)

On the other hand, with respect to the NI point alteration, the nematic-isotropic phase transition temperature was measured at 10° C./min scanning in a temperature range from 0 to 110° C. by using a DSC apparatus and the alteration of the nematic-isotropic phase transition temperature (NI point) was calculated according to the following equation.

Alteration of NI point=(NI point before the test)−(NI point after the test)

The results are shown in Table 7.

### EXAMPLE 8

### Preparation of Copolymer

At first, 117.7 parts of a monomer mixture comprising n-butyl acrylate 70 mol %, glycidyl acrylate 15 mol % and acrylic acid 15 mol % was dissolved in 352.9 parts of diethylene glycol dimethyl ether and the obtained solution was fed to a separable flask and after replacement with nitrogen, while 11.8 parts of a diethylene glycol dimethyl ether solution containing 10% by weight of an oil-soluble azo type polymerization initiator (trade name: V-65, manufactured by Wako Pure Chemical Industries, Ltd.) was dropwise added for 2 hours, polymerization reaction was carried out.

After that, a copolymer (9) was obtained in the same manner as Example 7. A copolymer solution (9) and a spacer particle dispersion (9) were obtained in the same manner as Example 7, except the obtained copolymer (9) was used in place of the copolymer (8).

With respect to the obtained spacer particle dispersion (9), the same evaluations as those in Example 7 were carried out. The results are shown in Table 7.

### EXAMPLE 9

### Preparation of Copolymer

At first, 117.7 parts of a monomer mixture comprising methyl acrylate 60 mol %, glycidyl acrylate 20 mol % and acrylic acid 20 mol % was dissolved in 352.9 parts of diethylene glycol dimethyl ether and the obtained solution was fed to a separable flask and after replacement with nitrogen, while 11.8 parts of a diethylene glycol dimethyl ether solution containing 10% by weight of an oil-soluble azo type polymerization initiator (trade name: V-65, manufactured by Wako Pure Chemical Industries, Ltd.) was dropwise added for 2 hours, polymerization reaction was carried out.

After that, a copolymer (10) was obtained in the same manner as Example 7. A copolymer solution (10) and a spacer particle dispersion (10) were obtained in the same manner as Example 7, except the obtained copolymer (10) was used in place of the copolymer (8).

With respect to the obtained spacer particle dispersion (10), the same evaluations as those in Example 7 were carried out. The results are shown in Table 7.

### EXAMPLE 10

### Preparation of Spacer Particle Dispersion

At first, 117.7 parts of a monomer mixture comprising methyl methacrylate 60 mol %, glycidyl acrylate 20 mol % and acrylic acid 20 mol % was dissolved in 352.9 parts of diethylene glycol dimethyl ether and the obtained solution was fed to a separable flask and after replacement with nitrogen, while 11.8 parts of a diethylene glycol dimethyl ether solution containing 10% by weight of an oil-soluble azo type polymerization initiator (trade name: V-65, manufactured by Wako Pure Chemical Industries, Ltd.) was dropwise added for 2 hours, polymerization reaction was carried out.

After that, a copolymer (11) was obtained in the same manner as Example 7. A copolymer solution (11) and a spacer particle dispersion (11) were obtained in the same manner as Example 7, except the obtained copolymer (11) was used in place of the copolymer (8).

With respect to the obtained spacer particle dispersion (11), the same evaluations as those in Example 7 were carried out. The results are shown in Table 7.

### (Experiment 8)

### (Preparation of Adhesive Component)

At first, 117.7 parts of a single monomer of 100 mol % of n-butyl acrylate was dissolved in 352.9 parts of diethylene glycol dimethyl ether and the obtained solution was fed to a separable flask and after replacement with nitrogen, while 11.8 parts of a diethylene glycol dimethyl ether solution containing 10% by weight of an oil-soluble azo type polymerization initiator (trade name: V-65, manufactured by Wako Pure Chemical Industries, Ltd.) was dropwise added for 2 hours, polymerization reaction was carried out.

After that, a copolymer (12) was obtained in the same manner as Example 7. A copolymer solution (12) and a spacer particle dispersion (12) were obtained in the same manner as Example 2, except the obtained copolymer (12) was used in place of the copolymer (8).

With respect to the obtained spacer particle dispersion (12), the same evaluations as those in Example 7 were carried out. The results are shown in Table 7.

### (Experiment 9)

### (Preparation of Adhesive Component)

At first, 117.7 parts of a monomer mixture comprising n-butyl acrylate 60 mol % and glycidyl acrylate 40 mol % was dissolved in 352.9 parts diethylene glycol dimethyl ether and the obtained solution was fed to a separable flask and after replacement with nitrogen, while 11.8 parts of a diethylene glycol dimethyl ether solution containing 10% by weight of an oil-soluble azo type polymerization initiator (trade name: V-65, manufactured by Wako Pure Chemical Industries, Ltd.) was dropwise added for 2 hours, polymerization reaction was carried out.

After that, a copolymer (13) was obtained in the same manner as Example 7. A copolymer solution (13) and a spacer particle dispersion (13) were obtained in the same manner as Example 7, except the obtained copolymer (13) was used in place of the copolymer (8).

With respect to the obtained spacer particle dispersion (13), the same evaluations as those in Example 7 were carried out. The results are shown in Table 7.

TABLE 7

| | | | | | | | | | | | alteration | |
|---|---|---|---|---|---|---|---|---|---|---|---|---|
| | | | | | | | | | | | ratio | |
| | | | | | | number of spacer | | | | | of volume | |
| | | cohesive | | | | particles arranged | | | | | resistivity | alter- |
| | receding | power of | | | | on the substrate | | | | | of | ation |
| | contact | spacer | | | | (particle/drop) | | | 15% | spacer | liquid | of |
| | angle | particles | solvent | heat | storage | maxi- | mini- | | deformation | restration | crystal | NI point |
| | (degree) | (μN/particle) | resistance | resistance | resistance | mum | mum | average | stress (mN) | ratio (%) | (%) | (° C.) |
| Example 7 | 45 | 5.0 | 0 | −9% | ◯ | 18 | 0 | 7.1 | 21.7 | 93 | 45 | 0.03 |
| Example 8 | 44 | 5.0 | 0 | −10% | ◯ | 20 | 0 | 7.2 | 20.3 | 90 | 38 | 0.04 |
| Example 9 | 42 | 5.0 | 0 | −7% | ◯ | 18 | 0 | 7.0 | 23.4 | 95 | 50 | 0.03 |
| Example 10 | 47 | 5.0 | 0 | −8% | ◯ | 19 | 0 | 7.1 | 22.6 | 92 | 46 | 0.03 |
| Experiment 8 | 43 | 5.0 | entirely | −35% | ◯ | 18 | 0 | 7.0 | 20.0 | 91 | 28 | 0.57 |
| | | | separated | | | | | | | | | |
| Experiment 9 | 46 | 5.0 | entirely | −40% | ◯ | 19 | 0 | 7.1 | 20.1 | 92 | 31 | 0.64 |
| | | | separated | | | | | | | | | |

From Table 7, the spacer particle dispersions of Examples 7 to 10 were found having solvent resistance enough to stand alignment layer application and their weight alteration ratios by heating were suppressed to 10% or lower and on the other hand, the spacer particle dispersions of Experiments 8 and 9 showed apparently inferior solvent resistance and heat resistance.

In Examples 7 to 10, no spacer movement was observed by the vibration test, however spacer movement out of the light-blocking region occurred in Experiments 8 and 9.

### INDUSTRIAL APPLICABILITY

Accordingly, the invention provides a method of producing a liquid crystal display device, which comprises a step of ejecting a droplet of a spacer particle dispersion with an ink-jet apparatus, depositing the droplet at a prescribed position on a substrate, then drying the droplet, and thereby arranging the spacer particle on the substrate, and which may arrange the spacer particles precisely at prescribed positions.

### BRIEF DESCRIPTION OF THE DRAWINGS

FIG. 1 is a schematic view showing the fixation state of the spacer particles on the substrate on which the spacer is arranged and which is produced by the method of producing a liquid crystal display device of the invention.

FIG. 2 is a schematic view showing the droplets ejected out of an ink-jet nozzle and FIG. 2(a) shows the case the meniscus is asymmetric and FIG. 2(b) shows the case the meniscus is symmetric.

FIG. 3 is a partially broken perspective view of a structure of one example of an ink-jet head.

FIG. 4 is an electron microscopic photograph of the arrangement state of the spacer particles using the spacer particle SA dispersion using the adhesive component solution A.

FIG. 5 is an electron microscopic photograph of the arrangement state of the spacer particles using the spacer particle SB dispersion using the adhesive component solution A.

FIG. 6(a), 6(b) is a graph showing the alteration of the contact angle of the droplet of the spacer particle dispersion during the drying process.

FIG. 7 is an explanatory drawing illustrating the contact angle of the spacer particle dispersion to the substrate.

FIG. 8 is a schematic view schematically showing the apparatus for measuring the receding contact angle of the droplet of the spacer particle dispersion to the substrate in Example 1.

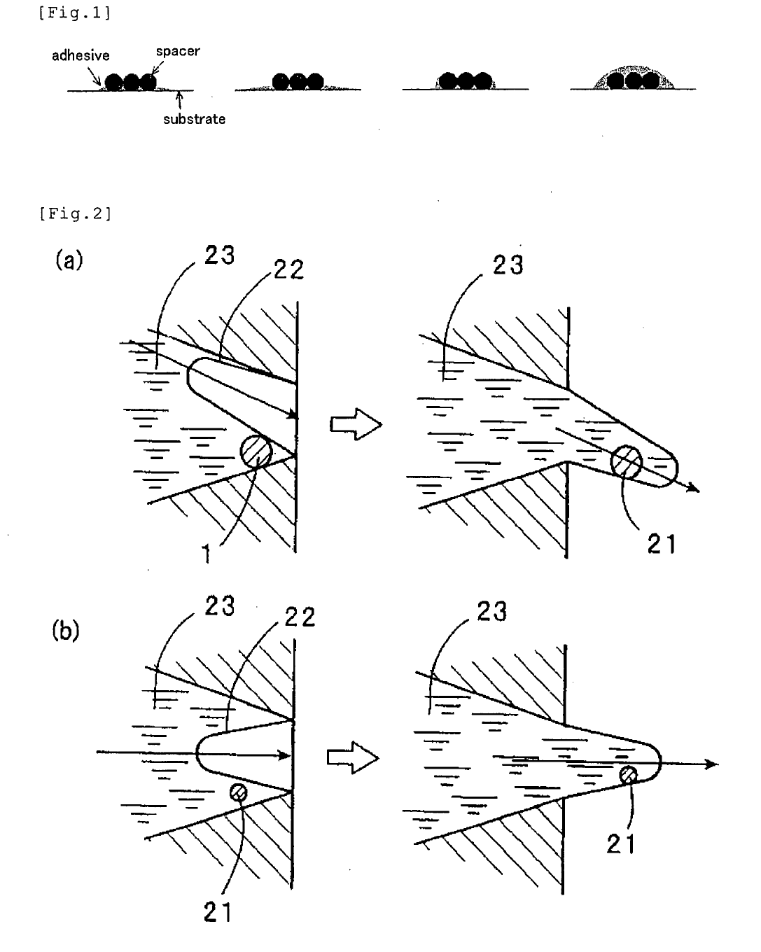

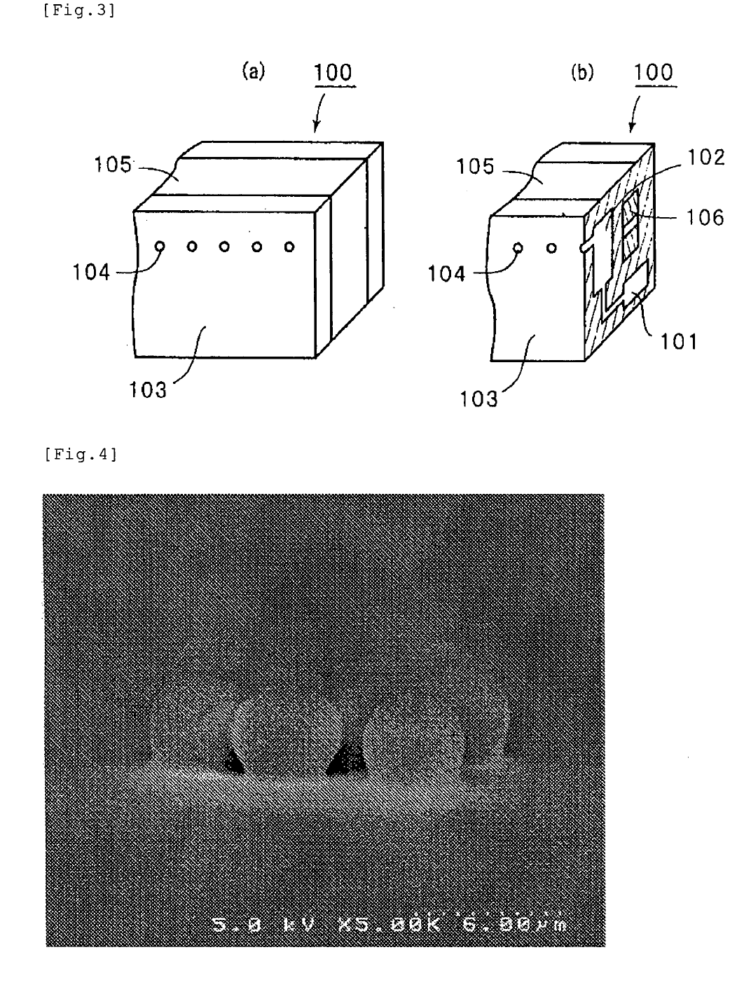

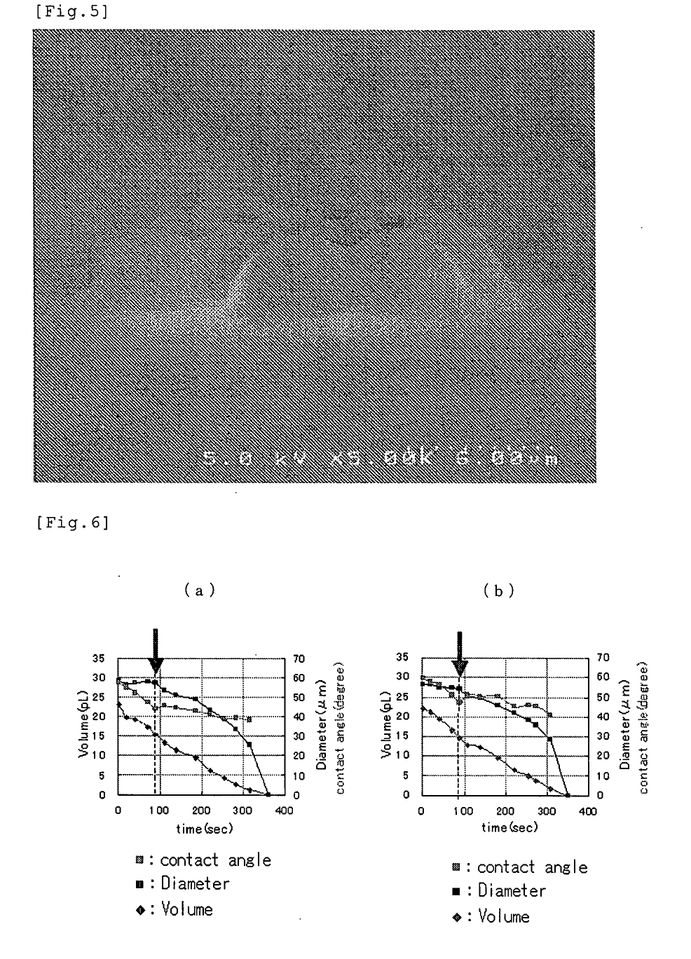

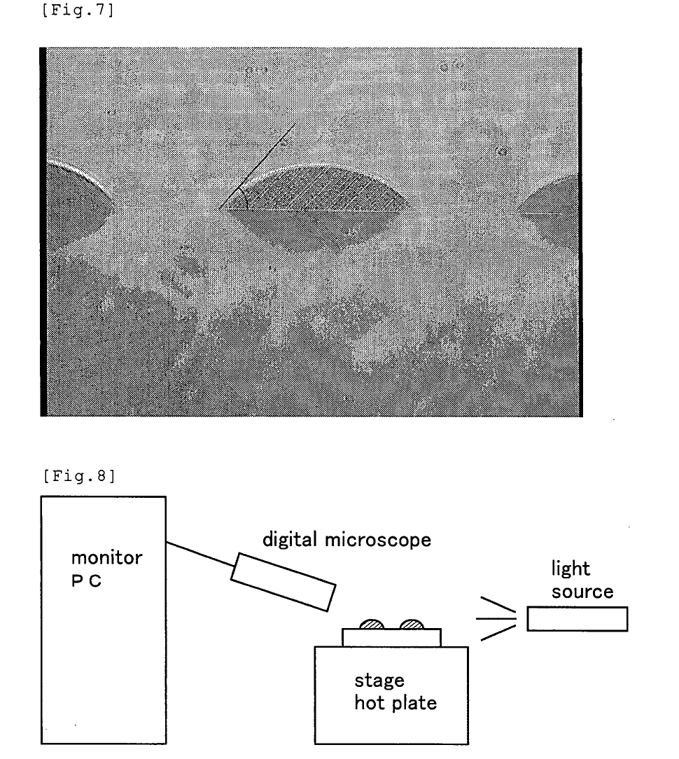

### EXPLANATION OF SYMBOLS

21 spacer particles
22 meniscus
23 spacer particle dispersion
100 head
101 ink chamber 1 (common ink chamber)
102 ink chamber 2 (pressure ink chamber)
103 ejection face (nozzle face)
104 nozzle hole
105 temperature control means
106 piezoelectric element

1. A method of producing a liquid crystal display device,
which comprises a step of ejecting a droplet of a spacer particle dispersion with an ink-jet apparatus, depositing the droplet at a prescribed position on a substrate, then drying the droplet, and thereby arranging the spacer particle on the substrate,
the spacer particle dispersion comprising a spacer particle, an adhesive component and a solvent,
the spacer particle after the drying being arranged in a narrower region than the diameter of the droplet of the spacer particle dispersion deposited on the substrate.

2. The method of producing a liquid crystal display device according to claim 1,
wherein the spacer particle dispersion has a receding contact angle in a range from 5 to 70 degree to the substrate.

3. The method of producing a liquid crystal display device according to claim 1,
wherein the substrate is previously subjected to water-repelling treatment to have a contact angle of 20 degree or wider to the spacer particle dispersion.

4. A spacer particle dispersion,
which comprises a spacer particle, an adhesive component and a solvent, and is used for the method of producing a liquid crystal display device according to claim 1.

5. The spacer particle dispersion according to claim 4,
wherein the droplet ejected on the substrate shows a receding contact angle in a range from 5 to 70 degree.

6. The spacer particle dispersion according to claim 4,
wherein a difference between a specific gravity of the spacer particle and a specific gravity of a liquid portion other than the spacer particle is 0.2 or narrower.

7. The spacer particle dispersion according to claim 4, 5 or 6,
which has a surface tension in a range from 25 to 50 mN/m and a value obtained by subtracting a value of a surface tension of the substrate from a value of the surface tension in a range from −2 to 40 mN/m.

8. The spacer particle dispersion according to claim 4,
wherein the spacer particle has a surface treatment layer.

9. The spacer particle dispersion according to claim 4,
wherein a difference between a solubility parameter value of a surface of the spacer particle and a solubility parameter value of the liquid portion other than the spacer particle is 5.0 or narrower.

10. A spacer particle dispersion,
which contains a spacer particle, an adhesive component and a solvent,
the adhesive component being a mixture of a copolymer (A) having a repeating unit represented by the following general formula (1) and a repeating unit represented by the following general formula (2), a content of the repeating unit represented by the general formula (1) being 5 to 90% by mole and a content of the repeating unit represented by the general formula (2) being 10 to 95% by mole, and at least one kind of polyvalent compound (B) selected from the group consisting of polycarboxylic anhydride, polycarboxylic acid, aromatic polyphenol and aromatic polyamine: 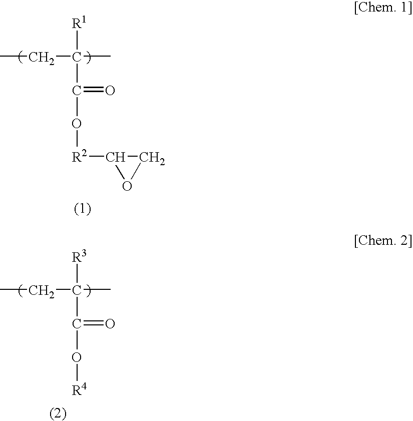
(in the formula, R¹ and R³ independently represent hydrogen atom or methyl group; R² represents an alkyl group having 1 to 8 carbon atoms; R⁴ represents an alkyl group having 1 to 12 carbon atoms, a cycloalkyl group having 5 to 12 carbon atoms, or an aromatic group; and the cycloalkyl group and aromatic group may have a substituent group).

11. A spacer particle dispersion,
which contains a spacer particle, an adhesive component and a solvent,
the adhesive component being a copolymer having a repeating unit represented by the following general formula (1), a repeating unit represented by the following general formula (2), a repeating unit derived from an unsaturated carboxylic acid and/or an unsaturated carboxylic anhydride, and a content of the repeating unit represented by the general formula (1) being 1 to 70% by mole, a content of the repeating unit represented by the general formula (2) being 10 to 98% by mole, and a content of the repeating unit derived from an unsaturated carboxylic acid and/or an unsaturated carboxylic anhydride being 1 to 70% by mole: 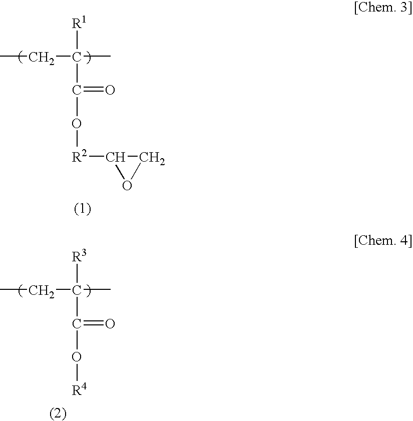
(in the formula, R¹ and R³ independently represent hydrogen atom or methyl group; R² represents an alkyl group having 1 to 8 carbon atoms; R⁴ represents an alkyl group having 1 to 12 carbon atoms, a cycloalkyl group having 5 to 12 carbon atoms, or an aromatic group; and the cycloalkyl group and aromatic group may have a substituent group).

12. The spacer particle dispersion according to claim 4,
wherein the solvent is at least one kind selected from the group consisting of ethylene glycol, propylene glycol, diethylene glycol, 1,4-butanediol, ethylene glycol diacetate, diethylene glycol monoethyl ether acetate, glycerin, triacetin, dimethyl phthalate, diethyl phthalate, dimethyl malonate, diethyl malonate, ethyl acetoacetate, and methyl lactate.

13. A liquid crystal display device,
which is obtained by using the method of producing a liquid crystal display device according to claim 1.

14. A liquid crystal display device, which is obtained by using the spacer particle dispersion according to claim 4.
